(19) United States
(12) Patent Application Publication
(10) Pub. No.: US 2025/0279820 A1
(43) Pub. Date: Sep. 4, 2025

(54) METHOD AND APPARATUS FOR DETECTING USER EQUIPMENT IN WIRELESS COMMUNICATION SYSTEM

(71) Applicant: Samsung Electronics Co., Ltd., Gyeonggi-do (KR)

(72) Inventors: Byounghoon JUNG, Gyeonggi-do (KR); Anil AGIWAL, Gyeonggi-do (KR)

(21) Appl. No.: 18/858,958

(22) PCT Filed: May 3, 2023
(86) PCT No.: PCT/KR2023/006083

§ 371 Date: Oct. 22, 2024

(30) Foreign Application Priority Data
May 3, 2022 (KR) 10-2022-0055098

(51) Int. Cl. H04B 7/06; H04L 27/26; H04W 74/0833

(52) U.S. Cl. CPC H04B 7/06952; H04L 27/2605; H04W 74/0833

(57) ABSTRACT

The present disclosure relates to an ultra-high frequency communication system such as 5G or 6G for supporting a higher data transmission rate. A method performed by a base station in a wireless communication system may be provided in the present disclosure. The method comprises the steps of: transmitting a first signal to user equipment (UE), the first signal including UE detection channel (UDCH) resource information for UE selection; and receiving, from the UE, a second signal including UE detection information on the basis of the UDCH resource information in an observation period corresponding to a period for detecting UE, wherein the observation period may be greater than or equal to a preamble length included in the second signal.

### TECHNICAL FIELD

The disclosure relates to a wireless communication system and, particularly, to a method and a device for detecting a user terminal in a wireless communication system.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks. AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to provide methods for efficient integrated access and backhaul node control.

### DISCLOSURE OF INVENTION

### Technical Problem

Disclosed embodiments provide a device and a method capable of efficiently providing services in a mobile communication system.

### Solution to Problem

According to various embodiments of the disclosure, a method performed by a base station in a wireless communication system may be provided. The method may include transmitting a first signal to a terminal, the first signal including user equipment (UE) detection channel (UDCH) resource information for terminal selection, and receiving, from the terminal, a second signal including terminal detection information, based on the UDCH resource information in an observation period corresponding to a period for terminal detection, wherein the observation period is longer than or equal to a preamble length included in the second signal.

According to various embodiments of the disclosure, a method performed by a terminal may be provided. The method may include receiving a first signal from a base station, the first signal including user equipment (UE) detection channel (UDCH) resource information for terminal selection, and transmitting, to the base station, a second signal including terminal detection information, based on the UDCH resource information, wherein an observation period corresponding to a period in which the base station receives the second signal is longer than or equal to a preamble length included in the second signal.

According to various embodiments of the disclosure, a base station in a wireless communication system may be provided. The base station may include a transceiver, and a controller connected to the transceiver, wherein the controller is configured to transmit a first signal to a terminal, the first signal including user equipment (UE) detection channel (UDCH) resource information for terminal selection, and receive, from the terminal, a second signal including terminal detection information, based on the UDCH resource information in an observation period corresponding to a period for terminal detection, wherein the observation period is longer than or equal to a preamble length included in the second signal.

According to various embodiments of the disclosure, a terminal in a wireless communication system may be provided. The terminal may include a transceiver, and a controller connected to the transceiver, wherein the controller is configured to receive a first signal from a base station, the first signal including user equipment (UE) detection channel (UDCH) resource information for terminal selection, and transmit, to the base station, a second signal including terminal detection information, based on the UDCH resource information, wherein an observation period corresponding to a period in which the base station receives the second signal is longer than or equal to a preamble length included in the second signal.

According to the disclosure, a method performed by a terminal may include: receiving a first signal including at least one reference signal from a base station: identifying a reference signal corresponding to an optimal beam among the at least one reference signal; transmitting a second signal to the base station, based on a resource corresponding to the identified reference signal corresponding to the optimal beam; receiving, from the base station, a third signal including physical random-access channel (PRACH) resource information corresponding to the second signal; and transmitting a fourth signal to the base station, based on the PRACH resource information.

### Advantageous Effects of Invention

Disclosed embodiments provide a device and a method capable of efficiently providing services in a mobile communication system.

### BRIEF DESCRIPTION OF DRAWINGS

FIG. 1 is a diagram illustrating a procedure for transmitting a random-access preamble in a multi-beam-based system according to an embodiment of the disclosure;

FIG. 2 is a diagram illustrating a random-access procedure in a wireless communication system according to an embodiment of the disclosure;

FIG. 3 is a diagram for illustrating a random-access preamble format according to an embodiment of the disclosure;

FIG. 4A to FIG. 4B are diagrams for illustrating an example of a random-access preamble format suitable for an ultra-high frequency system, such as 6G, according to an embodiment of the disclosure:

FIG. 5 is a diagram for illustrating a random-access preamble transmission procedure according to an embodiment of the disclosure;

FIG. 6 is a flowchart for illustrating a random-access preamble transmission procedure of a UE according to an embodiment of the disclosure:

FIG. 7 is a flowchart for illustrating a random-access preamble transmission procedure of a base station according to an embodiment of the disclosure:

FIG. 8 is a flowchart for illustrating a random-access preamble signal length based on an increase in frequency according to an embodiment of the disclosure;

FIG. 9 is a flowchart for illustrating a random-access preamble signal length based on cell coverage according to an embodiment of the disclosure:

FIG. 10A to FIG. 10D are diagrams illustrating a structure of a random-access preamble transmission slot using a short preamble signal and an observation period for preamble signal detection of a base station according to an embodiment of the disclosure;

FIG. 11 is a diagram for illustrating whether a guard time is required in a random-access preamble structure according to an embodiment of the disclosure:

FIG. 12 is a diagram for illustrating whether a guard time is required in a random-access preamble structure according to an embodiment of the disclosure;

FIG. 13 is a diagram illustrating a random-access preamble transmission procedure according to an embodiment of the disclosure;

FIG. 14 is a diagram illustrating overheads of existing and proposed random-access preamble transmission procedures according to an embodiment of the disclosure;

FIG. 15 is a diagram illustrating a random-access preamble transmission procedure according to an embodiment of the disclosure;

FIG. 16 is a diagram illustrating a random-access preamble transmission procedure according to an embodiment of the disclosure;

FIG. 17 is a diagram illustrating a random-access preamble transmission procedure according to an embodiment of the disclosure;

FIG. 18A to FIG. 18C illustrate a random-access preamble structure according to an embodiment of the disclosure;

FIG. 19 is a diagram illustrating an example of a random-access preamble structure according to an embodiment of the disclosure;

FIG. 20A is a diagram illustrating a conventional random-access procedure;

FIG. 20B is a diagram illustrating a PRACH slot configuration for RAP transmission;

FIG. 20C is a diagram illustrating a lower limit value of T_SEQ for diversifying target coverage when antenna gain has been adjusted to compensate for an increased path loss;

FIG. 20D is a diagram illustrating an RAP overhead of an existing 5G network;

FIG. 20E is a diagram illustrating an RAP overhead of a proposed 5G network;

FIG. 20F is a diagram illustrating UEs that perform random access;

FIG. 20G is a diagram illustrating overheads of conventional and proposed RAP protocols;

FIG. 21 is a diagram illustrating a schematic structure of a base station according to an embodiment of the disclosure;

FIG. 22 is a diagram illustrating a schematic structure of a UE according to an embodiment of the disclosure; and

FIG. 23 is a flowchart for illustrating a random-access preamble transmission procedure of a UE according to an embodiment of the disclosure.

### MODE FOR THE INVENTION

Hereinafter, exemplary embodiments of the disclosure will be described in detail with reference to the accompanying drawings. It should be noted that, in the accompanying drawings, the same or like elements are designated by the same or like reference signs as much as possible. Also, a detailed description of known functions or configurations that may make the subject matter of the disclosure unnecessarily unclear will be omitted.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or any other programmable data processing apparatus. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

The following detailed description of embodiments of the disclosure is directed to ultrahigh frequency mobile communication technology such as 6G beyond the 5G mobile communication, but based on determinations by those skilled in the art, the main idea of the disclosure may be applied to other communication systems having similar technical backgrounds through some modifications without significantly departing from the scope of the disclosure.

In the following description, some of terms and names defined in the 3rd generation partnership project long term evolution (3GPP LTE) standards (standards for 5G. NR, LTE, or similar systems) may be used for the convenience of description. However, the disclosure is not limited by these terms and names, and may be applied in the same way to systems that conform other standards.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as used herein, and other terms referring to subjects having equivalent technical meanings may be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description of the disclosure, terms and names defined in the 3rd generation partnership project new radio (3GPP NR) or 3rd generation partnership project long term evolution (3GPP LTE) standards will be used for the sake of descriptive convenience. However, the disclosure is not limited by these terms and names, and may be applied in the same way to systems that conform other standards. In the disclosure, the term “gNB” may be interchangeably used with the term “eNB” for the sake of descriptive convenience. That is, a base station described as “eNB” may refer to “gNB”. Furthermore, the term “terminal” may refer to not only a mobile phone, an MTC device, an NB-IoT device, and a sensor, but also other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

Furthermore, as used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

The disclosure relates to a method and a device for detecting a user terminal (hereinafter, referred to as a UE) in a next-generation wireless communication system. More specifically, the disclosure relates to a method and a device for a base station to efficiently detect UEs required to use different directional analog beams at different locations in an ultra-high frequency system, such as a present 3GPP 5G new radio (NR) and a future 6G, which enable data transmission and reception via directional analog beamforming by using multiple antennas.

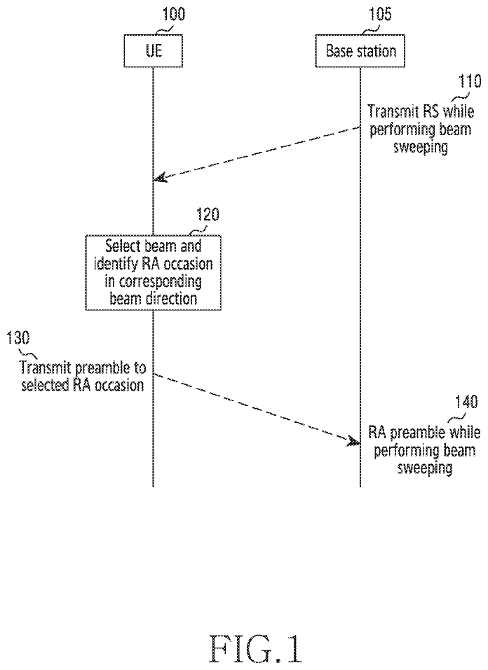

FIG. 1 is a diagram illustrating a procedure for transmitting a random-access preamble in a multi-beam-based system according to an embodiment of the disclosure.

A procedure for transmitting a random-access preamble based on beamforming in 3GPP NR is as follows.

A base station 105 may transmit a synchronization signal block (SSB) or a reference signal (RS) in rotation for each beam (beam sweeping), as in operation 110. Here, beams may be any antenna configuration of the base station, may be analog directional beams that have directivity toward physically different locations and have output differences, and digital beams that may be understood with logically different codes.

As in operation 120, a terminal (or user equipment (UE)) 100 receives a signal transmitted by the base station 105 in rotation for each signal, and selects a base station beam suitable for exchanging information, for example, an optimal beam, a beam with the best reception performance, or a beam with the best reception performance among beams having performance equal to or higher than a specific threshold. In addition, the UE 100 identifies uplink random-access occasion (hereinafter, referred to as RA occasion) information corresponding to a selected beam direction, based on physical random-access channel (hereinafter, referred to as PRACH) configuration information. In this case, a UE that has not yet accessed a cell may receive system information (hereinafter, referred to as SI) to identify PRACH configuration information, and a UE that has already accessed a cell may identify PRACH configuration information, based on previously received PRACH configuration information.

As in operation 130, the UE 100 transmits a random-access preamble on a corresponding resource, based on the identified RA occasion information.

As in operation 140, the base station 105 performs beam sweeping on one or more preconfigured PRACHs, for example, PRACHs configured in all base station beam directions, and receives a random-access preamble.

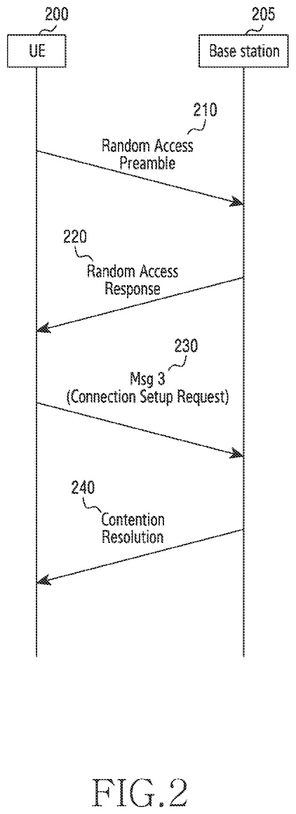

FIG. 2 is a diagram illustrating a random-access procedure in a wireless communication system according to an embodiment of the disclosure.

As described in FIG. 1 above, in operation 210, a UE 200 may transmit a random-access preamble to a base station 205, and the base station may receive the random-access preamble while performing beam sweeping.

In operation 220, the base station 205 may transmit, to UE 200, a random-access response corresponding to the received random-access preamble. In this case, the random-access response may include allocation information of an uplink resource, on which the UE 200 receiving the random-access response may transmit Msg 3, and a temporary UE ID (temporary C-RNTI) to be used at that time.

In operation 230, the UE 200 having received the random-access response may identify the allocation information of the uplink resource and the temporary UE ID, and transmit Msg 3 on the corresponding resource. In this case, the UE intending to perform initial access may perform transmission including a connection setup request message.

In operation 240, the base station 205 having received Msg 3 from the UE 200 transmits a contention resolution message to UEs having successfully received Msg 3 so as to inform that random access has been successfully completed. This contention resolution message may include a connection setup message from the base station.

Although not illustrated, the UE 200 may then transmit a connection setup complete message to the base station 205 to complete a connection setup. When the connection setup is completed, the UE may acquire a formal UE ID (C-RNTI) to be used within the base station, and therefore all control signal transmission and reception to and from the base station are possible.

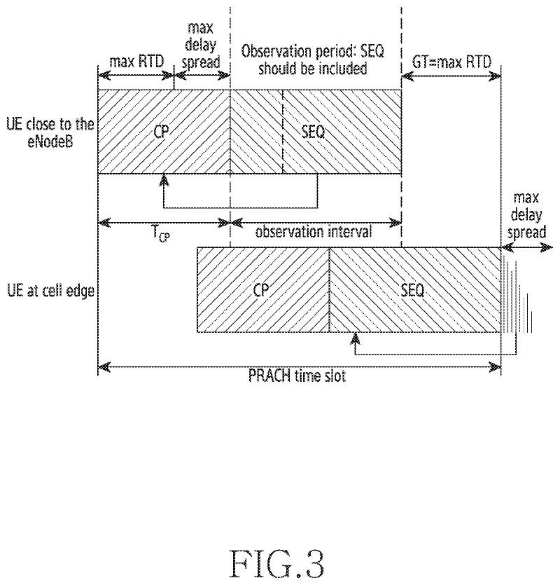

FIG. 3 is a diagram for illustrating a random-access preamble format according to an embodiment of the disclosure.

In the existing 3GPP LTE and NR, a random-access preamble may have various structures and lengths.

A random-access preamble (hereinafter, preamble) is transmitted while having a cyclic prefix (hereinafter, CP) with a certain length or greater in a frame so that signals transmitted by different UEs do not overlap or do not create gaps within coverage, and cyclically shifting a preamble signal (hereinafter, SEQ) therein. After the CP, one SEQ may be disposed, or the SEQ may be duplicated so that one or more SEQs may be disposed.

In addition, the preamble has a guard time (hereinafter, GT) to protect information that is continuously transmitted and received from inter-symbol interference.

When a random-access preamble available in an ultra-high frequency band, for example, a frequency band of several hundreds of GHz, is designed, a CP and a guard time (hereinafter. GT) may be determined by considering a maximum round-trip delay (hereinafter. RTD) and a maximum delay spread according to cell coverage. In addition, a sequence length may be determined by considering that the sequence length should be greater than or equal to the CP and should be an integer multiple of a data symbol.

In this way, a preamble transmission PRACH time slot structure having a length of 10 psec in a frequency band of several hundreds of GHz may be shorter than a length of a preamble currently used in NR of an mmWave band. However, when comparing a relative length with a data symbol, the preamble in the ultra-high frequency band, for example, a frequency band of several hundreds of GHz, is 30 times greater compared to data, which may be relatively greater than a preamble used in a mmWave band that is 2 to 12 times greater compared to data.

In addition, in the ultra-high frequency band, for example, a frequency band of several hundreds of GHz, in order to compensate for signal attenuation due to a frequency increase, a beam having a narrower beam width and higher antenna gain compared to a mmWave band system may need to be used. For example, even if a beam width is halved, the number of beams which should be used to satisfy the same coverage in a three-dimensional environment may be four times more.

Therefore, due to the larger number of beams compared to NR, the preamble of the ultra-high frequency band, for example, a frequency band of several hundreds of GHz, has a severe delay problem. For example, when a system in a 140 GHz frequency band uses 256 beams which are four times more than beams in NR, a base station does not know when an unspecified UE transmits an RA preamble and which beam direction the UE uses for the transmission, so that PRACH resources should be allocated for all beams receivable by the base station. According to an embodiment, the unspecified UE may be a UE which performs random access for connection while not in a connected state or a UE which is in a connected state but satisfies a specific condition and thus performs random access. That is, the base station should periodically and repeatedly allocate as many PRACH resources as the number of all beams. For example, if one PRACH resource requires 1 slot, i.e., 10 μsec, then a total of 256 slots, i.e., a time of 2.56 msec, may be required. Of course, if PRACH resources overlap frequency resources, a time occupied by the PRACH resources for all beams may be reduced by additionally using frequency resources instead of time resources.

In this way, the base station should periodically allocate PRACH resources, and the UE may need to wait for a period to transmit and retransmit a random-access preamble in a specific beam direction. In other words, a period for PRACH resource allocation itself may be a random-access delay of the UE. In order to improve the random-access performance of the UE, it is recommended to reduce the PRACH resource allocation period, but an overhead occupying resources may also increase as the period becomes shorter.

For example, when a frequency bandwidth occupied by PRACH resources is approximately ⅓ of a total bandwidth 400 MHz out of a 1.2 GHz bandwidth), overheads of resources occupied according to periods when PRACH resources are allocated in 256 beam directions are as shown in the following Table 1.

TABLE 1

| Periodicity | 20 ms | 40 ms | 80 ms | 160 ms | 320 ms |
|---|---|---|---|---|---|
| PRACH Overhead | 4.3% | 2.1% | 1.12% | 0.5% | 0.3% |

In this way, in order to reduce overheads occupying resources, PRACH resource allocation with a long period is inevitably required, and as a result, the UE may unavoidably experience a long delay during random-access attempt or reattempt.

In an LTE system using a single beam at low frequencies, a PRACH has an allocation period of 10 ms and a resource overhead of about 0.5%. However, in a future system using numerous beams at high frequencies, there may occur a disadvantage that, when a PRACH is configured and used, operation is performed so that one of a delay and a resource overhead should be sacrificed based on a tradeoff relationship between the delay and the resource overhead.

In addition, PRACH resources allocated in all base station beam directions are beam-swept every time and mostly wasted when preambles are received from unspecified UEs. For example, in an ultra-high frequency system operating 256 base station beams, a probability that there are UEs required to perform random access in 200 or more beam directions in every period may be very low. In order to offset signal attenuation due to a frequency at the ultra-high frequency, it is inevitable for the system using many beams to have limited coverage so as to have a small cell. A probability, which is obtained by multiplying a probability that a UE exists in a single base station beam direction in a small cell and a probability that the existing UE needs to perform random access, may be very low.

Most of the frequently allocated but unused PRACH resources may be discarded and wasted, which may cause a large amount of capacity waste in a next-generation wireless communication system having a very high data rate per unit resource. In addition, the base station should perform unnecessary and frequent beam changes, and the waste of power consumption resulting from this cannot be ignored.

A UE that is to perform random access may receive an SIB in a selected base station beam direction, identify PRACH resource allocation information included in the SIB, and then transmit a random-access preamble on a PRACH resource configured for the selected base station beam direction.

In this case, if the PRACH resource configured for the corresponding beam direction is located very late in time, for example, several hundreds of msecs later, the UE inevitably experiences a long-time delay until transmitting the random-access preamble. In addition, a large number of PRACH resources on which the UE does not actually transmit a random-access preamble are empty and wasted.

In addition, the existing NR system has a problem that, due to long sequence timing, a long preamble signal should be inevitably transmitted even if transmission power is sufficient.

In the future ultra-high frequency system, such as 6G, an actual required random-access preamble signal length is reduced due to high transmission power and short coverage, but a preamble signal longer than the CP may need to be transmitted due to uplink timing.

In the existing LTE and NR, a preamble sequence length is significantly longer than a cyclic prefix length in order to support coverage of a cell. For example, in the LTE, the CP is 100 psec, and a preamble signal is 800 psec which is 8 times the CP. In the NR, a preamble sequence length is various, that is about 2 to 8 times longer than the CP.

However, in consideration of increasing UE transmission power and decreasing cell size in a future ultra-high frequency wireless communication environment such as 6G, the sequence length required to support cell coverage may be significantly shorter than the cyclic prefix.

For example, for an ultra-high frequency wireless communication network such as 6G, which has a coverage of 500 m and transmission power of 50 dBm and operates at a frequency of 140 GHz, a CP having a length of 3.2 μsec may be required, but 1.67 μsec of a Zadoff-Chu sequence length may be sufficient.

In addition, the random-access preamble is used to adjust timing required for the UE to ensure that, when performing uplink transmission, the transmission is received by the base station at an accurate slot boundary. To this end, “auto-correlation with a cyclically shifted version of itself is also zero” which is one of properties of a Zadoff-Chu sequence of the random-access preamble is used. A difference between delay signals transmitted by UEs and an actual reception signal slot boundary of the base station may be measured using “auto-correlation with a cyclically shifted version of itself is also zero”. The measured difference is used as an RTD, and timing adjustment (hereinafter, TA) is performed to adjust timing by causing the UE to start performing transmission earlier by RTD/2.

To this end, the random-access preamble signal length and a corresponding base station observation period should be greater than or equal to the CP.

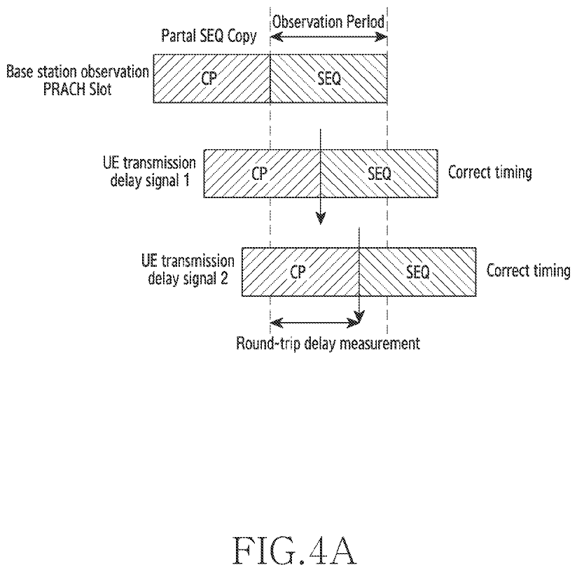

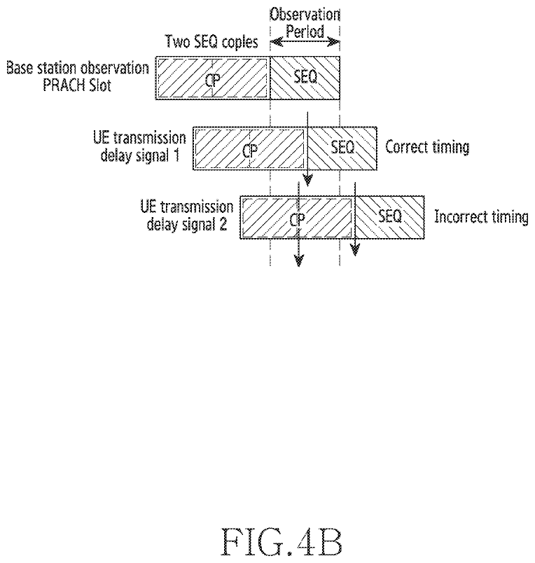

FIG. 4A to FIG. 4B are diagrams for illustrating an example of a random-access preamble format suitable for the ultra-high frequency system, such as 6G, according to an embodiment of the disclosure.

FIG. 4A is a diagram for illustrating a case where a preamble signal length is longer than or equal to a CP. Referring to FIG. 4A, a base station may measure an accurate round-trip delay and may properly measure a peak of only one preamble signal within an observation period not only for delay signal 1 transmitted by a relatively close UE but also for delay signal 2 transmitted by a distant UE.

However, if a preamble signal length is shorter than a CP, measuring such an accurate RTD may be difficult.

FIG. 4B is a diagram for illustrating a case where a preamble signal length is shorter than a half of a CP. Referring to FIG. 4B, abase station may identify a peak of a duplicated sequence within a CP with respect to delay signal 2 transmitted by a distant UE, and this has a value different from an RTD that should actually be measured, making proper timing adjustment impossible.

An assumption is made for a case where a random-access preamble suitable for the ultra-high frequency, such as 6G, is configured by considering a CP length, a guard time, coverage, and timing. According to an embodiment, a preamble signal (sequence) length is longer than a CP length, and may be about twice longer than a preamble signal length actually required for coverage.

The preamble slot structure and length designed in this way may affect the delay and overhead according to the PRACH transmission period discussed above, and may also affect an amount of wasted resources due to a configuration in a beam direction in which no UE exists.

However, in consideration of coverage, timing, etc., it is also obvious that the CP or preamble signal length cannot be reduced any further, so that approach to another method is required.

Various embodiments of the disclosure propose new channels, signal structures, and protocols enabling efficient delay reduction and resource allocation by considering the random-access preamble slot structure.

In the existing NR system, a base station transmits an SSB by beam sweeping, allocates RACH resources for all beam directions, and informs a UE of the allocation via broadcasting, and the UE identifies an RACH resource corresponding to a selected beam and performs RACH using the same.

However, due to an excessive number of beams and relatively long PRACH resources, a random-access delay and an overhead may occur. In order to reduce this overhead, a proposed technique may be used so that the UE and the base station detect a location of the UE before configuring PRACH resources, and perform a pre-procedure for determining a beam direction in which the UE exists and thus PRACH resource configuration is required.

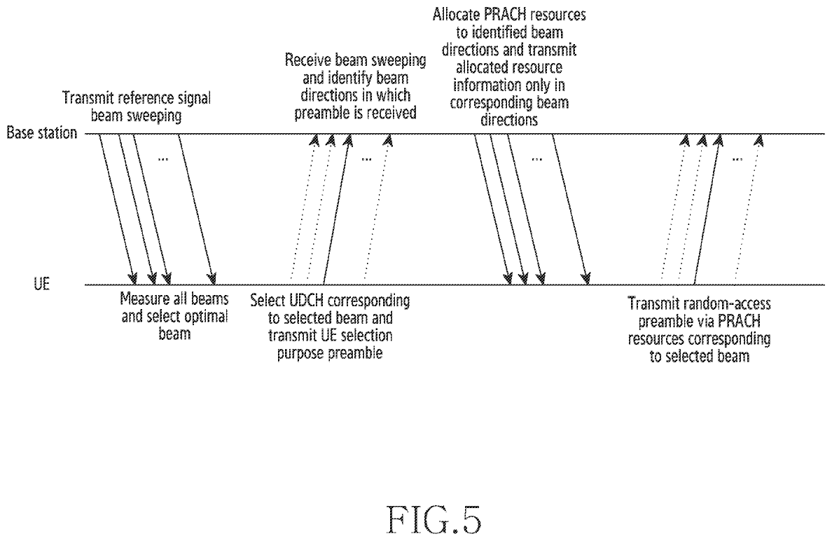

FIG. 5 is a diagram for illustrating a preamble transmission procedure according to an embodiment of the disclosure.

The disclosure is available for any system which needs to detect various UEs out of sync and to identify a base station beam direction to which a UE belongs. However, as a representative embodiment, a random-access procedure may be considered.

A random-access procedure according to various embodiments of the disclosure includes identifying a base station beam, via which a base station is able to perform transmission and reception to and from a UE, for example, a base station beam corresponding to a location of the UE, and then configuring a PRACH resource. In the existing system, a beam via which communication with a UE may be performed cannot be identified, and therefore a base station inevitably configures PRACH resources for all base station beam directions. However, in the system according to an embodiment of the disclosure, a beam direction in which a UE exists may be first identified. Then, a PRACH resource corresponding to a beam direction in which a UE exists may be configured, thereby providing the PRACH resource required for the UE. Based on this, a random-access preamble delay of a UE can be minimized, and a wasted PRACH resource can be removed, thereby maximizing resource efficiency. According to a method for a base station to recognize that a UE exists in a specific beam direction according to an embodiment of the disclosure, a UE may transmit a short signal to a base station via, for example, a user detection channel (UDCH) (or UE detection channel), and the base station may receive the signal and identify the presence of the UE. In this case, a name of the user detection channel is merely an example, and all channels used to inform the base station of the presence of the UE or a beam direction (SSB ID or CSI-RS ID) in which the UE exists may be included.

According to an embodiment of the disclosure, the base station may transmit reference signals, for example, SSBs (or CSI-RSs), in all operating beam directions. According to an embodiment, a UE may receive SSBs (or CSI-RSs) of the base station while changing its own beam, and select an optimal base station SSB (or CSI-RS).

The UE may transmit an uplink signal via a UDCH associated with the selected optimal base station SSB (or CSI-RS), and the base station may receive the signal and identify that the UE is in a (QCL-ed) beam direction that is correlated with an SSB (or CSI-RS) of a specific base station.

The base station may allocate PRACH resources in specific beam direction(s) corresponding to base station beam directions in which communication with UEs is estimated to be possible, and may inform the UEs of information on the allocated PRACH resources. In this case, a new system information block, for example, SIB-α, may be defined with a new protocol for configuration of information.

The UE may transmit a random-access preamble to the base station, based on the received PRACH resource information, and the base station may receive the same, based on the PRACH resource information.

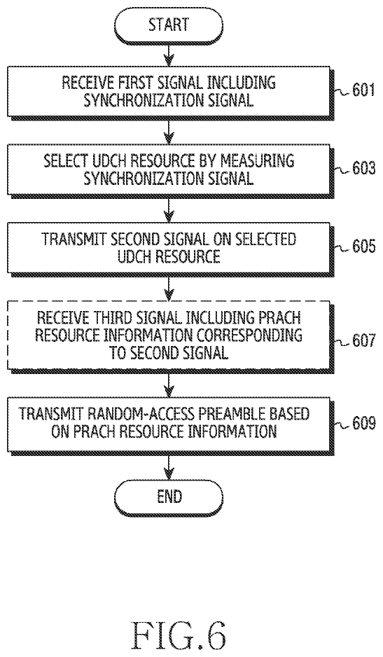

FIG. 6 is a flowchart for illustrating a random-access preamble transmission procedure of a UE according to an embodiment of the disclosure.

In operation 601, a UE may receive a first signal including a synchronization signal. According to an embodiment, the UE may receive the first signal including a reference signal transmitted by a base station. The base station transmits the first signal by beam sweeping. Each reference signal transmitted by sweeping may correspond to each beam or beams.

In this case, the first signal may include a synchronization signal (SS) or a broadcast signal (e.g., a master information block (MIB) or a system information block (SIB)). For another example, the first signal may not include a synchronization signal. For another example, the first signal may not include a broadcast signal. If the first signal does not include a broadcast signal, the base station may transmit a broadcast signal to the UE via a separate signal.

The broadcast signal may include, for example, at least one of UDCH uplink resource information and downlink resource information for transmission of SIB-a that is certain system information.

SIB-α may be, for example, a signal including PRACH resource information according to an embodiment of the disclosure. Here, SIB-α resource information is resources expressed in frequency and time, and a reference signal (beam) having a correlation (e.g., quasi co location, hereinafter, QCL relationship) with each resource may be configured. The resources may be fixedly allocated all the time, or when variable allocation is needed, for example, when an uplink signal is received/detected via a UDCH correlated with a certain reference signal, only a downlink channel correlated with the reference signal may be allocated. An indicator indicating determination on this allocation may also be included in the broadcast signal.

The UDCH may be a channel via which a signal transmitted by the UE to the base station is transmitted in order to identify a base station beam via which the base station is able to communicate with the UE, according to the embodiment of the disclosure. UDCH resource information is resources expressed in frequency and time, and a reference signal (beam) having a correlation (e.g., QCL relationship) with each resource may also be directly configured.

Alternatively, indirectly, information on multiple channel resources configured in standards and an ID indicating the reference signal (beam) correlated with each resource may be transmitted and configured via the broadcast signal. For example, the broadcast signal may include PRACH resource information for each beam according to an embodiment.

In operation 603, the UE may select a UDCH resource by measuring the synchronization signal. According to an embodiment, the UE may identify UDCH resource information, which enables uplink signal transmission, via the received broadcast signal, and select a UDCH resource corresponding to the selected reference signal (beam) by measuring the reference signal. The UE may select a reference signal having the best performance (RSSI, RSRP, RSRQ, CQI, etc.) while changing its reception antenna configuration (by changing a beam direction) or may select a reference signal exceeding a specific threshold value. In addition, a reference signal corresponding to an optimal beam may be selected in various ways.

In operation 605, the UE may transmit a second signal on the selected UDCH resource. According to an embodiment, the UE may transmit the second signal (e.g., a user detection signal) on the UDCH resource that is correlated (e.g., QCL-ed) with the determined reference signal (beam). The second signal is used by the base station to receive or detect the second signal from the UDCH and identify the reference signal or beam that is correlated with the UDCH. That is, the base station may receive the second signal to identify the reference signal (or beam) corresponding to a base station beam direction in which communication with the UE is estimated to be possible.

In operation 607, the UE may receive a third signal including PRACH resource information corresponding to the second signal. According to an embodiment, the UE may receive the third signal including the PRACH resource information via the SIB-α resource. The third signal may have a newly defined SIB-a protocol. The PRACH resource information may include resource configuration information related to the reference signal (beam) which has been identified based on the second signal received on the UDCH and corresponds to the base station beam direction in which communication with the UE is estimated to be possible. The PRACH resource information may include resource information expressed in frequency and time, or may indicate some or all of the PRACH resources configured above via the broadcast signal in a bitmap format.

According to an embodiment of the disclosure, the UE may receive no third signal. In this case, the UE may identify resource information corresponding to the reference signal (beam) determined in the PRACH resource information (resource information configuration for each beam) received via the broadcast signal. That is, the UE that has informed, via the UDCH, the base station of the base station beam direction in which communication with the UE is estimated to be possible may identify the PRACH resource associated with the base station beam corresponding to the UDCH without receiving additional signaling.

In operation 609, the UE may transmit a random-access preamble, based on the PRACH resource information. For example, the UE may transmit the random-access preamble on the identified PRACH resource. The UE may start random access by transmitting the random-access preamble via the PRACH resource that is correlated with the determined reference signal (beam).

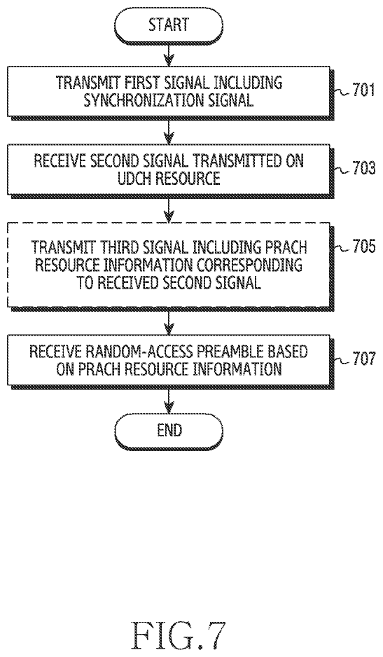

FIG. 7 is a flowchart for illustrating a random-access preamble reception procedure of a base station according to an embodiment of the disclosure.

In operation 701, a base station may transmit a first signal including a synchronization signal. According to an embodiment, the base station may periodically transmit the first signal including a reference signal. The base station transmits the first signal by beam sweeping. Each reference signal transmitted by sweeping may correspond to each beam.

In this case, the first signal may include a synchronization signal (SS) or a broadcast signal (e.g., a master information block (MIB) or a system information block (SIB)). For another example, the first signal may not include a synchronization signal. For another example, the first signal may not include a broadcast signal. If the first signal does not include a broadcast signal, the base station may transmit a broadcast signal to the UE via separate signaling (e.g., SIB).

The broadcast signal may include, for example, at least one of SIB-α resource information and UDCH resource information.

SIB-α may be, for example, a signal including PRACH resource information according to an embodiment of the disclosure. Here, the SIB-α resource information is resources expressed in frequency and time, and a reference signal (beam) having a correlation (e.g., QCL relationship) with each resource may be configured. The resources may be fixedly allocated all the time, or when variable allocation is needed, for example, when the base station receives/detects an uplink signal via a UDCH correlated with a certain reference signal, only a downlink channel correlated with the reference signal may be allocated. An indicator indicating determination on this allocation may also be included in the broadcast signal.

The UDCH may be a channel via which a signal transmitted by the UE to the base station is transmitted in order to identify a base station beam direction in which the base station is estimated to be capable of communicating with the UE, according to the embodiment of the disclosure. The UDCH resource information is resources expressed in frequency and time, and a reference signal (beam) having a correlation (e.g., QCL relationship) with each resource may be also be directly configured.

Alternatively, indirectly, information on multiple channel resources configured in the standards and an ID indicating the reference signal (beam) correlated with each resource may be transmitted and configured via the broadcast signal. For example, the broadcast signal may include PRACH resource information for each beam according to an embodiment.

In operation 703, the base station may receive a second signal transmitted on a UDCH resource. According to an embodiment, the base station may receive/detect the second signal (e.g., a user detection signal) on the uplink via the configured UDCH. The second signal is used to identify a reference signal correlated with the UDCH. That is, the base station may receive the second signal to identify a reference signal (or beam) corresponding to a UE location, in other words, corresponding to a base station beam direction in which communication with the UE is estimated to be possible.

In operation 705, the base station may transmit a third signal including PRACH resource information corresponding to the received second signal. For example, the base station may transmit the third signal including the PRACH resource information corresponding to (correlated with) the identified reference signal (beam) via the SIB-α resource.

The third signal may have a newly defined SIB-α protocol. The PRACH resource information may include resource configuration information related to the reference signal (beam) which corresponds to the UE location identified based on the second signal received on the UDCH and corresponds to the base station beam direction in which communication with the UE is estimated to be possible. The PRACH resource information may include resource information expressed in frequency and time, or may indicate some or all of the PRACH resources configured above via the broadcast signal in a bitmap format.

According to an embodiment of the disclosure, the third signal may not be transmitted. In this case, the UE may identify resource information corresponding to the reference signal (beam) determined in the PRACH resource information (resource information configuration for each beam) received via the broadcast signal. That is, the UE that has informed, via the UDCH, the base station of base station beam information enabling communication with the UE may identify the PRACH resource associated with the base station beam corresponding to the UDCH, on which an uplink signal has been transmitted, without receiving additional signaling. The base station may identify PRACH resource information corresponding to the reference signal (beam) that is correlated with the received second signal.

In operation 707, the base station may receive a random-access preamble, based on the PRACH resource information. According to an embodiment, the base station may receive the random-access preamble on PRACH resources. The base station may start random access by receiving the random-access preamble via the PRACH resource that is correlated with the reference signal identified by receiving the second signal.

According to various embodiments of the disclosure, the base station may configure UDCH resource information of a serving cell of the UE and/or an adjacent cell other than the serving cell via a signal other than a broadcast signal, for example, an RRC signal. For example, the RRC signal may be RRC reconfiguration or measurement configuration. The UE may transmit the second signal to the serving cell and/or the adjacent cell via a resource corresponding to the selected beam, based on the configured UDCH resource information. The base station having received the second signal may configure, for the UE, a PRACH resource corresponding to the selected beam. Alternatively, the UE may transmit the random-access preamble on the resource corresponding to the selected beam, based on the previously received PRACH resource information, and the base station may receive the random-access preamble via a resource corresponding to a beam that is correlated with the second signal. For example, the PRACH resource information may include resource information corresponding to each beam.

In the technique of the related art, an observation period during which a base station receives and actually detects a random-access or UE detection preamble signal (hereinafter, described as a preamble signal) transmitted by an unspecified UE is configured to be equal to an actual preamble signal length excluding a CP, as shown in FIG. 3. However, when observation is performed only for the preamble signal length, if the preamble signal length is not long enough, it may be difficult to observe a preamble signal. For example, if a total amount of energy for the preamble signal received by the base station is not large enough compared to noise, it may be difficult to observe the preamble signal. Due to this difficulty, in a conventional operation, if a specific condition is not satisfied, the preamble signal length cannot be reduced as much as desired.

For example, when the amount of energy required for the base station to successfully receive the preamble signal is Eₚ, a required preamble signal length may have the following relationship as in Equation 1.

$${T}_{SEQ} \geq \frac{{N}_{0} {N}_{f}}{{P}_{R x}} \frac{{E}_{p}}{{N}_{0}} = \frac{{E}_{p} {N}_{f}}{{P}_{R x}} , \qquad [ Equation 1 ]$$

Here, N₀ is a noise power density per frequency. N_{f} is a receiver noise figure, and P_{Rx} is an intensity of an uplink reception signal received by the base station, which is expressed in dB in Equation 2 as follows.

$${P}_{R x} = {P}_{Tx} + {G}_{ant} - P L - {P}_{Loss} \qquad [ Equation 2 ]$$

Here, P_{Tx} is a transmission power intensity of the UE. Gₐₙₜ is transmission/reception antenna gain of the UE and the base station. PL is signal attenuation according to a transmission/reception distance and frequency, and P_{Loss} is signal attenuation due to other factors.

Here, Eₚ is energy of the entire transmitted Zadoff-Chu sequence, and Eₚ/N₀ is Zadoff-Chu sequence energy per noise. In a typical urban 6-ray channel model, generally for 17 dB, a false alarm probability of 1% and a missed detection probability of 1% may be achieved. For example, in the 4G LTE environment, when Eₚ/N₀ is 18 dB, a false alarm probability of 0.1% and a missed detection probability of 1% may be achieved.

Subsequent to receiving a signal from a farthest UE in consideration of cell coverage of the base station, in which a service is available, a signal length required to accurately measure a delay may have the following relationship as in Equation 3.

$${T}_{SEQ} \geq {T}_{RTD} + {T}_{d} , \qquad [ Equation 3 ]$$

Here, T_{RTD} is a transmission/reception signal delay (round-trip delay (RTD)) experienced by the UE located furthest from the base station in the cell coverage, and T_{d} is a maximum delay spread due to multi-path, which may be experienced during signal transmission and reception at a specific frequency or in a specific environment.

In the conventional structure, a preamble signal length that satisfies both of the conditions above has the following relationship as in Equation 4.

$${T}_{SEQ} \geq max ( {T}_{RTD} + {T}_{d} , \frac{{E}_{p} {N}_{f}}{{P}_{R x}} ) \qquad [ Equation 4 ]$$

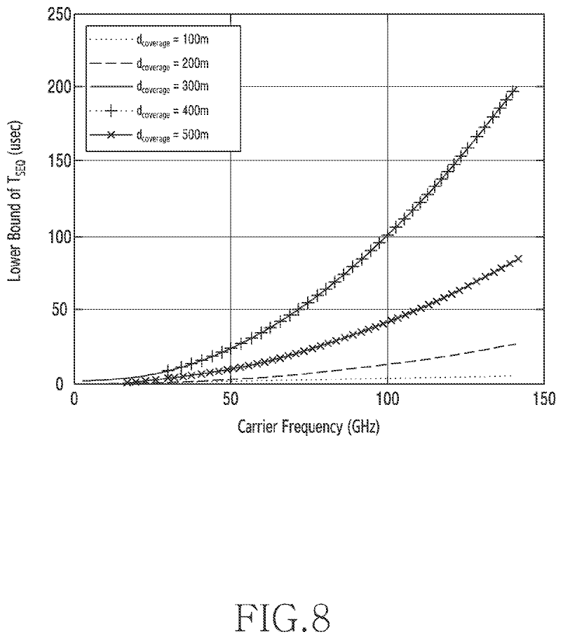

FIG. 8 is a flowchart for illustrating a random-access preamble signal length based on an increase in frequency according to an embodiment of the disclosure. FIG. 8 illustrates a minimum preamble signal length required in a conventional technology as a frequency and cell coverage (d_{coverage}) increase while Gₐₙₜ is fixed to 28 dBi when an antenna technology of a base station and that of a UE are the same. As can be seen in FIG. 8, a required preamble signal length significantly increases without advancement of the antenna technology or reduction of cell coverage.

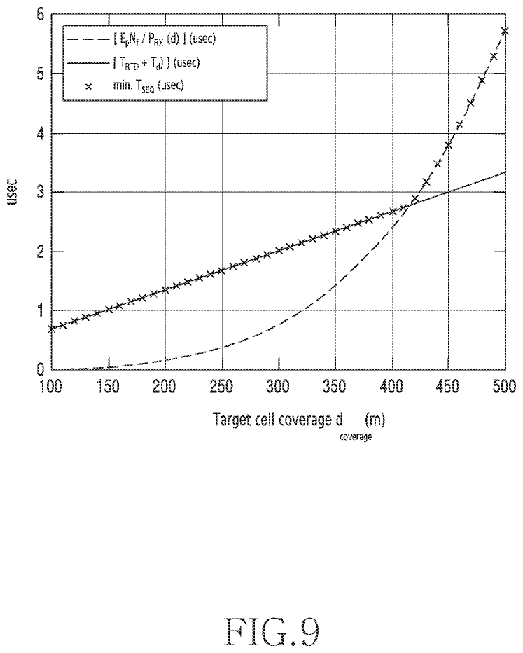

FIG. 9 is a flowchart for illustrating a random-access preamble signal length based on cell coverage according to an embodiment of the disclosure. Referring to FIG. 9, an assumption is made for a system in which it is possible to provide antenna gain (Gₐₙₜ) sufficient to compensate for a path loss. In FIG. 9, a minimum preamble signal length required as cell coverage changes is schematically illustrated. According to FIG. 9, it is seen that, even if the antenna technology is advanced, if the cell coverage is greater than 415 m, the minimum preamble signal length is determined to be longer than an RTD in order to satisfy a required amount of reception energy.

Therefore, if the antenna technology of the base station and the UE is not sufficiently advanced or the cell coverage required by the base station is not small, the preamble signal length cannot be smaller than the RTD. This indicates that it is difficult for the proposed UDCH to use fewer resources compared to a conventional PRACH.

In order to overcome this problem, fundamental changes in operation are required, other than a change in the antenna technology or cell coverage, and the fundamental changes are proposed in the operations described below.

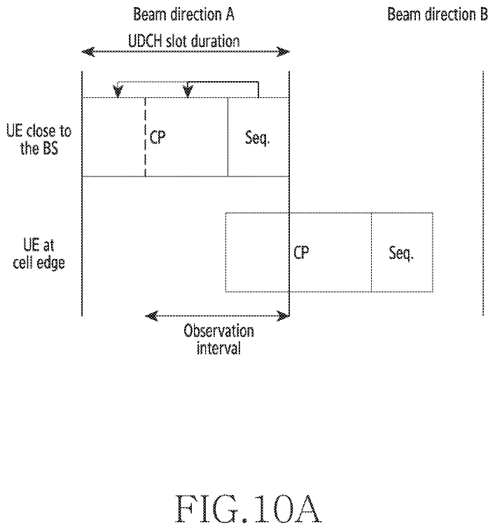

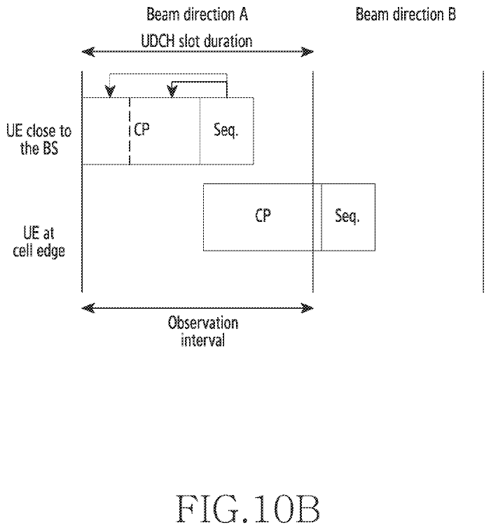

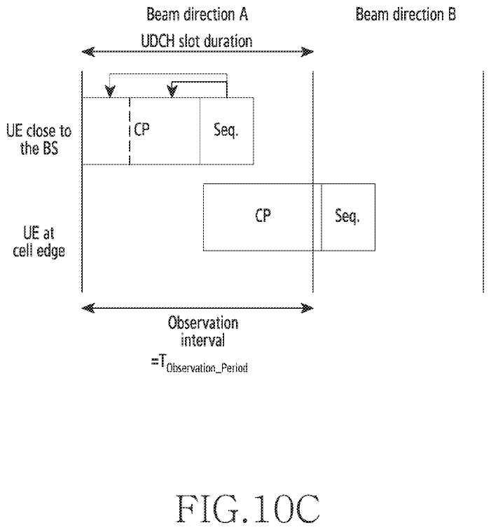

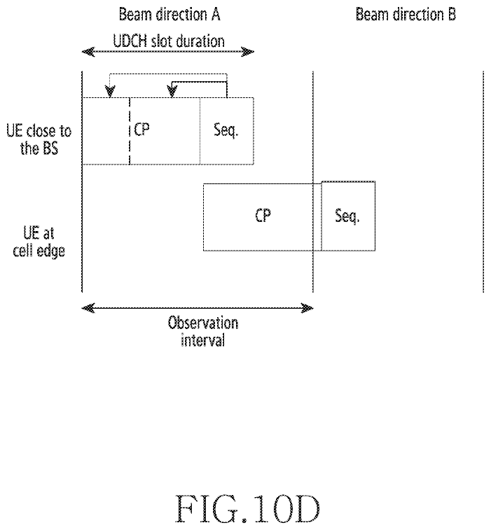

FIG. 10A to FIG. 10D are diagrams illustrating a structure of a random-access preamble transmission slot using a short preamble signal and an observation period for preamble signal detection of a base station according to an embodiment of the disclosure.

FIG. 10A illustrates, as an embodiment proposed in the disclosure, one structure of a second signal as a transmission and detection structure of a short preamble signal available for the purpose of detecting a UE. The most significant feature of the proposed structure is that an overhead interval is configured to be longer than a sequence length, thereby increasing a total energy amount of a preamble received by a base station. Based on this, system overhead is reduced by reducing a total preamble signal length while ensuring successful reception. Via this, the proposed preamble signal structure enables use of a short-length preamble signal even without changing the antenna technology or cell coverage.

Referring to FIG. 10A, in the conventional structure, a preamble signal length should be longer than or equal to a CP. This allows a base station to properly measure not only delay signal 1 transmitted by a relatively close UE, but also delay signal 2 transmitted by a distant UE. According to an embodiment, within an observation period, only one preamble signal peak may be properly measured, and an accurate round-trip delay (RTD) may be measured.

However, the main purpose of a preamble signal transmitted by a UE in a UDCH channel, which is proposed herein, is UE detection and detection of a beam direction in which a UE exists, so that there is no need to accurately measure an RTD or a delay of each UE. Therefore, an assumption is made for a case where one or more peaks rather than one preamble signal peak are detected within one observation period. When one or more peaks are detected, there is no problem in performing the purpose of UDCH, which is UE detection and detection of a beam direction in which a UE exists, and this indicates that there is no problem even if an observation period is longer than a preamble signal length.

When the proposed technique of a structure having a long observation period is used, a UE and a base station can successfully transmit and receive a short-length preamble signal without any constraints on a received signal strength in all environments. For example, all environments may be, for example, an environment having low antenna gain or an environment having greater target cell coverage.

In order to use the structure proposed in the disclosure, in which an observation period is longer than a preamble signal, a base station should be able to specify an observation period length in a slot on which a UE transmits a preamble signal. An observation period longer than a preamble signal (sequence) should have, as a minimum value, the following equation having a minimum length required in consideration of an intensity of a base station reception signal. According to an embodiment, an intensity of a base station reception signal may be determined according to cell coverage operated by the base station, antenna configurations of the base station and the UE, transmission/reception power, a carrier frequency, etc.

$${T}_{Observation \_ Period} \geq {min}_{k ϵ N} ( {k T}_{s} ) s . t . k {T}_{s} \geq \frac{{E}_{p} {N}_{f}}{{P}_{R x} ( r , f )} \qquad [ Equation 5 ]$$

Here, T_{Observation_Period} denotes a length of an observation period, k denotes any natural number, and T_{S} denotes a length of a unit symbol (or slot or any unit length) of a radio frame. In the disclosure, T_{Observation_Period} is determined by a function of a reception signal intensity determined according to cell coverage and frequency. However, according to another embodiment, T_{Observation_Period} may be determined as a length having a condition of a minimum reception signal period that satisfies any other condition receivable by the UE.

In various embodiments, the observation period may have, for example, the same length as the length described in FIG. 10B.

FIG. 10B illustrates an embodiment in which an observation period has a length equal to a UDCH slot length including the entire UDCH slot. Here, the UDCH slot may include a CP, a sequence, and a GT and may, of course, include only a CP and a sequence.

FIG. 10C illustrates an embodiment in which an observation period has a length equal to T_{Observation_Period} satisfying Equation 5 above, where an end part of a sequence is an end point. Here, a UDCH slot may include a CP, a sequence, and a GT and may, of course, include only a CP and a sequence.

FIG. 10D illustrates an embodiment in which an observation period has an equal length corresponding to a length obtained by adding a length of a CP and a length of a sequence, except for a guard time. Here, a UDCH slot may include a CP, a sequence, and a GT and may, of course, include only a CP and a sequence.

In another embodiment, the observation period may be configured to be a time interval within any UDCH slot which has a length equal to longer than T_{Observation_Period} satisfying Equation 5 above and includes a start part and an end part of the sequence. Here, the UDCH slot may include a CP, a sequence, and a GT and may, of course, include only a CP and a sequence.

In addition, of course, the observation period may be configured to be a time interval equal to an existing preamble signal (sequence) length.

The observation period determined in this way is configured, recognized, and available for the base station in the following manner.

In an embodiment, the observation period may be configured to be determined by one method so as to be included in the standards.

In an embodiment, the observation period may be determined such that each method is identified by an identifier, so as to be included in the standards. According to an embodiment, the observation period may be determined by the base station itself via an identifier, or may be determined for the base station by a higher management entity, for example, an entity of a core network, such as an access management function (AMF) or a session management function (SMF).

In an embodiment, the observation period may be determined by the base station or configured by a higher entity, and then a configuration value thereof may be transmitted to a UE. In this case, in order for the configuration value to be transmitted to the UE, an identifier of the configuration value may be broadcast (e.g., an SSB, an SIB, a paging message, etc.), multicast, or transferred in a unicast manner. In this case, the identifier of the observation period may be transmitted by being included in a message, such as an RRC message, a MAC message (MAC-CE), or a PHY message (DCI parameter).

The preamble signal transmission structure using a long observation period proposed in the disclosure is more resource-efficient compared to an existing full beam sweeping-based random access when the number of UEs simultaneously performing random access is smaller. In addition, the preamble signal transmission structure is more resource-efficient compared to the existing full beam sweeping-based random access when a preamble signal for transmission in a UDCH is shorter. On the other hand, if a cell is too small and the number of UEs simultaneously performing random access within the cell is very large, or if it is difficult to shorten a preamble signal for transmission within a UDCH, resource efficiency will be poor. Accordingly, when a UE situation within a cell or coverage of the cell changes, there may occur a difference in the utility between the proposed preamble transmission structure using UE detection and the existing random-access preamble transmission structure, and in this case, a method is additionally proposed to enable the base station to optionally select a transmission structure.

It is assumed that the existing random-access preamble transmission structure is referred to as a first transmission structure, and the preamble signal transmission structure using a long observation period proposed in the disclosure is referred to as a second transmission structure. The disclosure proposes a method for a base station to selectively determine a transmission structure to be used and inform a UE of the determination.

The base station may compare different preamble transmission structures to select a more suitable transmission structure. In this case, comparison criteria for selecting a more suitable transmission structure may be as follows:

1. The base station may calculate a resource overhead of each transmission structure and select a transmission structure with less resource overhead. For example, when resource overheads are compared in terms of ratio, a result thereof may be expressed as a ratio of an amount of resource that each transmission structure should allocate fixedly or probabilistically to receive preambles from UEs relative to an amount of radio resource available to the base station at the entire time and frequency axes. For example, when resource overheads are compared in terms of resource amount, a result thereof may be expressed as an amount of resource that each transmission structure should allocate fixedly or probabilistically to receive preambles from UEs.

2. The base station may calculate average delays of UEs in each transmission structure and select a transmission structure with a less average delay.

3. The base station may observe performance of a UE, for example, an average delay of the UE, average resource usage of the UE, and whether the UE has successfully performed transmission, in each transmission structure for a certain period of time, and select a transmission structure with better performance.

The base station may provide information on a determined transmission structure to a UE so that the UE in a network may transmit a preamble to the base station by using the transmission structure determined as above. If a series of standardized transmission structures have different identifiers, for example, transmission structure IDs, the base station may transmit a signal including a corresponding identifier to the UE. In this case, in order for a transmission structure configuration value to be transmitted to the UE, an identifier of the configuration value may be broadcast (e.g., an SSB, an SIB, a paging message, etc.), multicast, or transferred in a unicast manner. In this case, the identifier may be transmitted by being included in a message, such as an RRC message, a MAC message (MAC-CE), or a PHY message (DCI parameter).

The UE identifies the transmission structure required for preamble transmission according to the received identifier, and transmits a preamble according to the transmission structure.

In another embodiment, the base station may support one or more transmission structures at the same time. For example, the base station may simultaneously have an uplink UDCH received while beam sweeping in certain beam directions and a PRACH received while beam sweeping in certain beam directions. In this case, the UE may transmit a preamble signal by using a specific uplink channel corresponding to a condition when the condition is satisfied according to configuration of the base station or determination of the UE.

For example, the base station may provide the UE with information on UDCH and PRACH resources and corresponding beam directions (e.g., SSB or CSI-RS ID). The configuration value may be broadcast (e.g., an SSB, an SIB, a paging message, etc.), multicast, or transferred in a unicast manner. In this case, an identifier may be transmitted by being included in a message, such as an RRC message, a MAC message (MAC-CE), or a PHY message (DCI parameter).

For example, when the UE measures periodic reference signals of the base station, and there is only one preamble transmission structure that supports a channel corresponding to the selected optimal beam direction, the UE may select the transmission structure and transmit a preamble in the following manner.

For example, when the UE measures periodic reference signals of the base station, and there are one or more preamble transmission structures that support a channel corresponding to the selected optimal beam direction, the UE may select the transmission structure and transmit a preamble in the following manner.
The UE may transmit a preamble by using a transmission structure that arrives earliest in time.
The UE may transmit a preamble by using a transmission structure that uses fewest resources.
The UE may transmit a preamble by using all transmission structures.
The UE may transmit a preamble by using one transmission structure supportable by the UE.

In an embodiment, reasons that a guard time may be removed between UDCH slots are as follows. Guard time basically exists to prevent performance degradation due to propagation delay, switching time, and inter-symbol interference between consecutively transmitted and received signals.

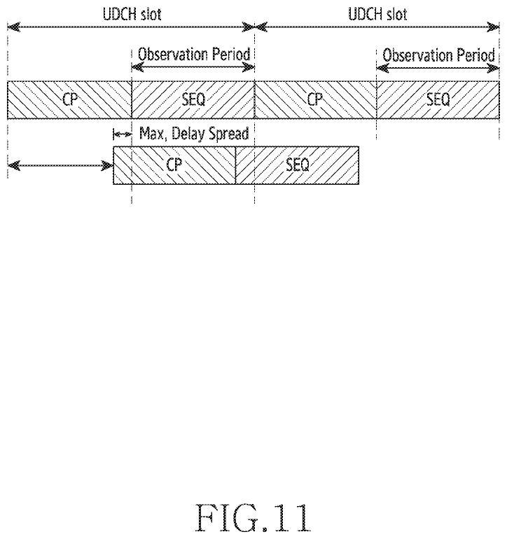

FIG. 11 is a diagram for illustrating whether a guard time is required in a random-access preamble structure according to an embodiment of the disclosure. Referring to FIG. 11, the influence between consecutively existing UDCH slots may be identified. The consecutively existing UDCH slots are configured to have sufficient CPs, and there should be no other sequence or influence included in an observation period in which a base station detects a sequence. Accordingly, it may be seen that there is no effect of delay, switching time, or inter-symbol interference caused by eliminating a guard time between consecutive UDCH slots having a CP with a length longer than a maximum delay spread. Therefore, there is no need to include a guard time between the consecutive UDCH slots.

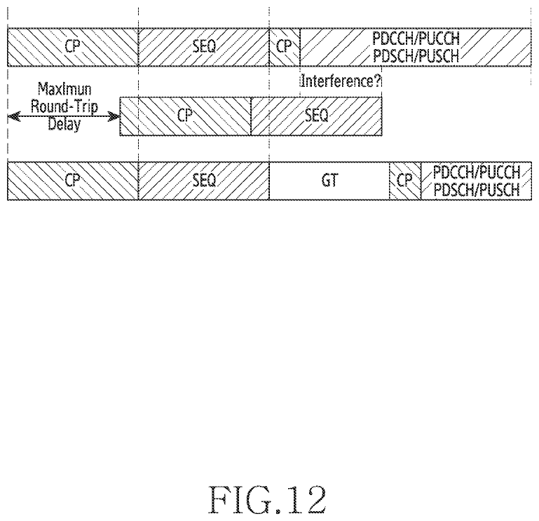

FIG. 12 is a diagram for illustrating whether a guard time is required in a random-access preamble structure according to an embodiment of the disclosure.

Referring to FIG. 12, when uplink/downlink control or data signal transmission follows a UDCH slot, if control or data signal transmission with a short-length CP follows subsequent to the UDCH slot, there may be an effect of interference due to another preamble transmission that experiences a round-trip delay. Accordingly, it may be seen that a guard time is required to eliminate the effect of interference when uplink/downlink control or data signal transmission follows the UDCH slot.

Therefore, in order to improve resource efficiency while eliminating an effect of interference, various embodiments of the disclosure provide a structure in which no guard time exists between consecutive UDCH slots, and a guard time is applied only once when consecutive UDCH slots end and a control/data slot starts.

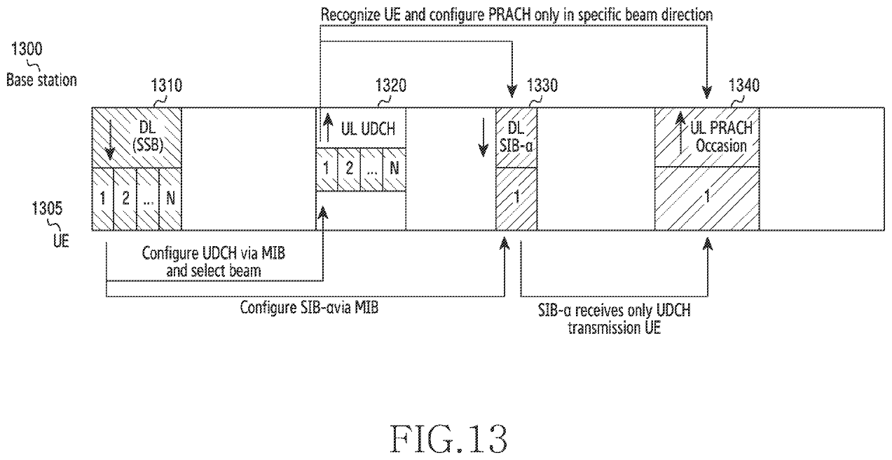

FIG. 13 is a diagram illustrating a random-access preamble transmission procedure according to an embodiment of the disclosure.

In operation 1310, a base station 1300 transmits a first signal to a UE 1305 via beam sweeping. The first signal includes a reference signal as described above, and may further include a broadcast signal. The first signal may be, for example, a reference signal such as an SSB or a CSI-RS.

The UE may receive the first signal transmitted by the base station in various beam directions and transmission/reception beam combinations, and select an optimal beam (reference signal).

The optimal beam may be a beam as follows.
a. Beam (SSB, CSI-RS, CRS, etc.) having the best reception signal performance (RSRP, RSRQ, SINR, SNR, CQI, RSSI)
b. Beam (SSB, CSI-RS, CRS, etc.) having reception signal performance exceeding a specific threshold (a value inherent in a UE or a value configured by a previously connected base station) value (RSRP, RSRQ, SINR, SNR, CQI, RSSI) and having the best reception signal performance (RSRP, RSRQ, SINR, SNR, CQI, RSSI)

The broadcast signal may include a downlink cell common resource configuration. For example, the broadcast signal may include the following resource information.
a. User detection channel (hereinafter, UDCH) resource information that enables short sequence transmission to notify the base station that the UE exists in a specific beam direction. A UDCH is resources on which the base station rotates in all beam directions to receive specific signals, and a resource for each beam may be configured.
b. Resource on which SIB-α including configured PRACH resource information is transmitted

According to an example, the UE may include resource information in the standards, and identify a resource by receiving an index indicating specific resource information via an MIB or an SIB. Alternatively, the UE may identify a resource by receiving an MIB or an SIB directly including resource information.

In operation 1320, the UE 1305 may transmit a second signal to the base station 1300 via an uplink UDCH channel. The UE may transmit the second signal via the UDCH to notify the base station that the UE exists in a corresponding beam direction. The UE identifies a resource configured for an optimal beam direction of the base station from the previously received UDCH resource information, and transmits the second signal on a UDCH resource corresponding to the corresponding beam.

In this case, the second signal may have various structures, and a signal of a structure agreed upon in advance between the base station and the UE should be transmitted. For example, the second signal may be a signal including a specific sequence, such as Zadoff-Chu, Gold, or M. In this case, a sequence length may be configured to be shorter than a sequence length of a random-access preamble. Alternatively, the second signal may be a signal that transmits fixed transmission power for a specific time period without information.

In operation 1330, the UE 1305 may receive a third signal including SIB-α from the base station 1300, based on received SIB-α resource information.

The base station may allocate a PRACH resource to a specific beam (SSB or CSI-RS) direction in which the presence of the UE is identified via the UDCH, and then transmit SIB-α including the allocated PRACH resource and beam (SSB or CSI-RS) information related to the resource.

In this case, the base station transmits an SIB-α signal only in the specific beam (SSB or CSI-RS) direction in which the presence of the UE is identified via the UDCH, and SIB-α resources for beams in which the presence of the UE is not identified may be reused for another downlink signal transmission.

The UE may receive the SIB-α signal via the resource allocated via the broadcast signal in advance, and identify PRACH resource information and beam information associated with each PRACH.

In operation 1340, the UE 1305 may transmit a random-access preamble to the base station 1300, based on the received PRACH resource information.

The UE may identify the PRACH resource related to the optimal beam of the base station in SIB-α, and transmit a random-access preamble signal on the PRACH resource related to the beam.

According to an embodiment of the disclosure, the signal that the UE is able to transmit on the UDCH may be designed in various ways. The purpose of the signal is to make the base station recognize the presence of the UE, and for this purpose, the signal does not need to include information on the UE, does not need to provide location or timing information on the UE, and does not need to be standardized.

Therefore, unlike the random-access preamble, an uplink UDCH transmission signal does not necessarily need to be equal to or longer than a CP length to provide timing, and may have a short sequence length different from an existing preamble.

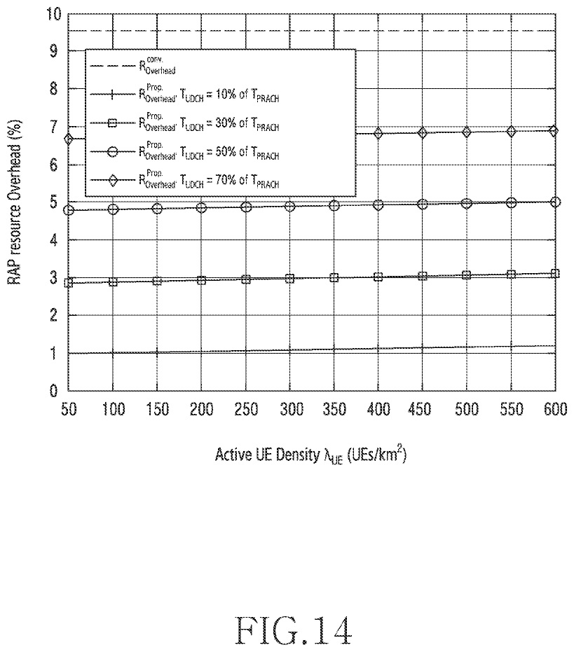

FIG. 14 is a diagram illustrating overheads of existing and proposed random-access preamble transmission procedures according to an embodiment of the disclosure. Referring to FIG. 14, when a wide cell coverage of 500 m is provided in an ultra-high frequency environment of a 96 GHz, a resource overhead consumed by a preamble signal transmission structure may be known. For example, when the proposed technique is used to sufficiently reduce a preamble signal length within a UDCH, a resource overhead consumed by a preamble signal transmission structure may be known in a practical environment. For example, the practical environment may refer to a case where the number of activated user UEs per square kilometer is 600 or less. According to FIG. 14, when the proposed technique is used, if the UDCH is sufficiently short by 10% to 30% of an existing PRACH length, overhead reduction of approximately 90% to 70% is shown. In addition, it may be seen that, if the UDCH is slightly long (50% to 70% of the existing PRACH length), overhead reduction of approximately 50% to 30% is shown. Therefore, it may be seen that resource efficiency of the proposed technique is superior to an existing full beam sweeping-based random-access preamble resource allocation method in the practical environment.

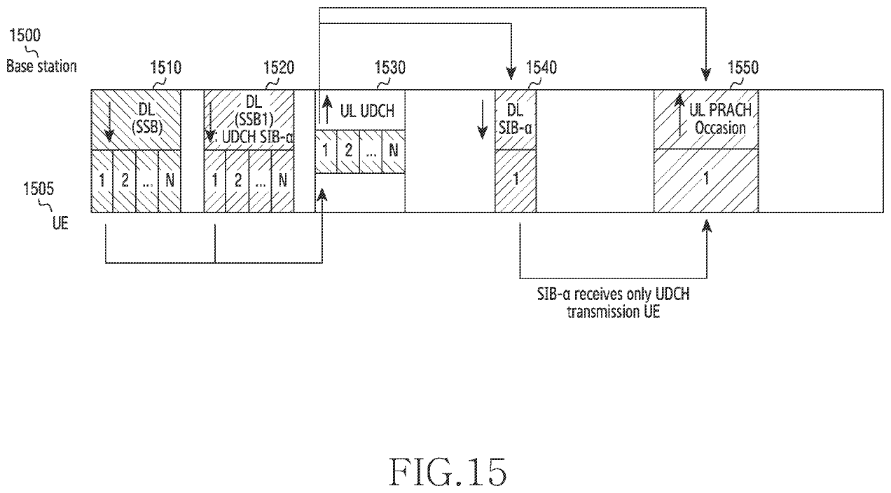

FIG. 15 is a diagram illustrating a random-access preamble transmission procedure according to an embodiment of the disclosure.

The embodiment illustrated in FIG. 15 is similar to the embodiment illustrated in FIG. 13. However, in FIG. 13, the broadcast signal is transmitted by being included in the first signal, but according to the embodiment, the broadcast signal may be transmitted via a separate SIB (e.g., an on-demand SIB).

In operation 1510, a base station 1500 transmits a first signal to a UE 1505 via beam sweeping. The first signal may include a reference signal. In addition, the first signal may include information (SIB resource information) on a resource on which an SIB is transmitted.

The UE may receive the first signal transmitted by the base station in various beam directions and transmission/reception beam combinations, and select an optimal beam (reference signal).

In operation 1520, the base station 1500 may transmit the SIB to the UE 1505, based on the SIB resource information. The SIB may include the following resource information.
a. User detection channel (UDCH) resource information which enables short sequence transmission to notify the base station that the UE is present in a specific beam direction. A UDCH is resources on which the base station rotates in all beam directions to receive specific signals, and a resource for each beam may be configured.
b. Resource on which SIB-α including configured PRACH resource information is transmitted

According to an example, the UE may include resource information in the standards, and identify a resource by receiving an index indicating specific resource information via the SIB. Alternatively, the UE may identify a resource by receiving the SIB directly including resource information.

In operation 1530, the UE 1505 may transmit a second signal to the base station 1500 via an uplink UDCH channel. The UE may transmit the second signal via the UDCH to notify the base station that the UE exists in a corresponding beam direction. The UE identifies a resource configured for an optimal beam direction of the base station from the previously received UDCH resource information, and transmits the second signal on a UDCH resource corresponding to the corresponding beam.

In operation 1540, the UE 1505 may receive a third signal including SIB-α from the base station 1500, based on received SIB-α resource information.

The base station may allocate a PRACH resource to the specific beam (SSB or CSI-RS) direction in which the presence of the UE is identified via the UDCH, and then transmit SIB-α including the allocated PRACH resource and beam (SSB or CSI-RS) information related to the resource.

In this case, the base station transmits an SIB-α signal only in the specific beam (SSB or CSI-RS) direction in which the presence of the UE is identified via the UDCH, and SIB-α resources for beams in which the presence of the UE is not identified may be reused for another downlink signal transmission.

The UE may receive the SIB-α signal via the allocated resource, and identify the PRACH resource information and beam information associated with each PRACH.

In operation 1550, the UE 1505 may transmit a random-access preamble to the base station 1500, based on the received PRACH resource information.

The UE may identify the PRACH resource related to the optimal beam of the base station in SIB-α, and transmit a random-access preamble signal on the PRACH resource related to the beam.

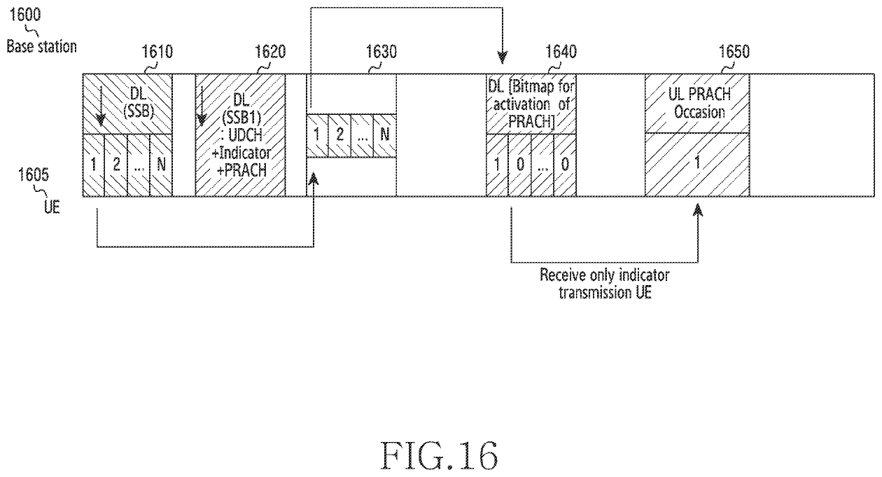

FIG. 16 is a diagram illustrating a random-access preamble transmission procedure according to an embodiment of the disclosure.

The embodiment illustrated in FIG. 16 is similar to the embodiment illustrated in FIG. 15, but in FIG. 16, a base station which recognizes the presence of a UE in a specific beam direction configures a PRACH resource for the UE and notifies the configuration by using a bitmap. According to an embodiment of the disclosure, a base station may configure, for a UE, PRACH candidate resource information for all beam directions via an SIB (e.g., SIB1) broadcast. The base station may notify activation (selection) of a resource corresponding to a selected beam in the PRACH candidate resource information, via a bitmap-based signal transmitted after PRACH resource configuration. When a bitmap corresponding to a PRACH of a specific beam direction is toggled (1), the UE having received the bitmap may recognize that a PRACH resource of the beam direction has been selected, and may transmit a random-access preamble via the resource.

In operation 1610, a base station 1600 transmits a first signal to a UE 1605 via beam sweeping. The first signal may include a reference signal. In addition, the first signal may include information (SIB resource information) on a resource on which an SIB is transmitted.

The UE may receive the first signal transmitted by the base station in various beam directions and transmission/reception beam combinations, and select an optimal beam (reference signal).

In operation 1620, the base station 1600 may transmit the SIB to the UE 1605, based on the SIB resource information. The SIB may include the following resource information.
a. User detection channel (UDCH) resource information which enables short sequence transmission to notify the base station that the UE is present in a specific beam direction. A UDCH is resources on which the base station rotates in all beam directions to receive specific signals, and a resource for each beam may be configured.
b. PRACH candidate resource information allocated for all beam directions, respectively.
c. In the PRACH candidate resource information, information on a resource for transmission of a bitmap-based signal that transmits activation (selection) of a resource corresponding to a selected beam.

In operation 1630, the UE 1605 may transmit a second signal to the base station 1600 via an uplink UDCH channel. The UE may transmit the second signal via the UDCH to notify the base station that the UE exists in a corresponding beam direction. The UE identifies a resource configured for an optimal beam direction of the base station from the previously received UDCH resource information, and transmits the second signal on a UDCH resource corresponding to the corresponding beam.

In operation 1640, the UE 1605 may receive, from the base station 1600, a bitmap-based third signal that transmits activation (selection) of the resource corresponding to the selected beam in the PRACH candidate resource information.

In operation 1650, the UE 1605 may transmit a random-access preamble to the base station 1600, based on the received PRACH resource information.

The UE may identify the PRACH resource related to the optimal beam of the base station in SIB-α, and transmit a random-access preamble signal on the PRACH resource related to the beam.

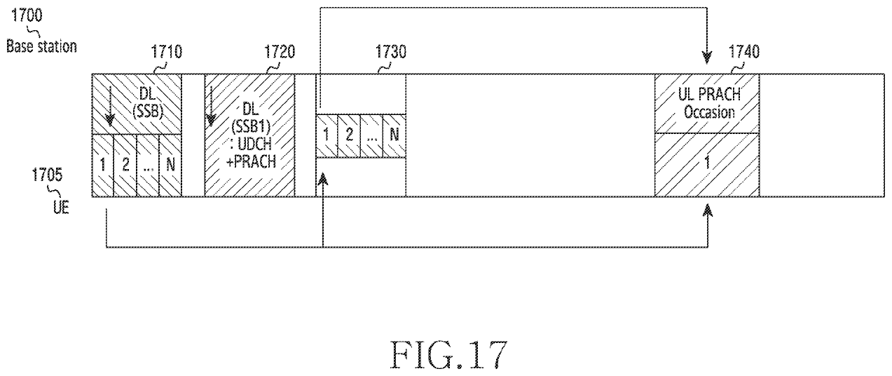

FIG. 17 is a diagram illustrating a random-access preamble transmission procedure according to an embodiment of the disclosure.

The embodiment illustrated in FIG. 17 is similar to the embodiment illustrated in FIG. 16, but in FIG. 17, a base station configures, for a UE, PRACH resource information for each beam via an SIB. In addition, only when a beam corresponding to a location of the UE is identified via a UDCH, the base station receives a random-access preamble by using a PRACH resource corresponding to the identified beam. That is, according to the embodiment, the UE and the base station may transmit and receive the random-access preamble without additional signaling for PRACH resource configuration.

In operation 1710, a base station 1700 transmits a first signal to a UE 1705 via beam sweeping. The first signal may include a reference signal. In addition, the first signal may include information (SIB resource information) on a resource on which an SIB is transmitted.

The UE may receive the first signal transmitted by the base station in various beam directions and transmission/reception beam combinations, and select an optimal beam (reference signal).

In operation 1720, the base station 1700 may transmit the SIB to the UE 1705, based on the SIB resource information. The SIB (e.g., SIB1) may include the following resource information.
a. User detection channel (UDCH) resource information which enables short sequence transmission to notify the base station that the UE is present in a specific beam direction. A UDCH is resources on which the base station rotates in all beam directions to receive specific signals, and a resource for each beam may be configured.
b. PRACH candidate resource information allocated for all beam directions, respectively.

In operation 1730, the UE 1705 may transmit a second signal to the base station 1700 via an uplink UDCH channel. The UE may transmit the second signal via the UDCH to notify the base station that the UE exists in a corresponding beam direction. The UE identifies a resource configured for an optimal beam direction of the base station from the previously received UDCH resource information, and transmits the second signal on a UDCH resource corresponding to the corresponding beam.

In operation 1740, the UE 1705 may identify PRACH resource information corresponding to the selected beam of the base station from the PRACH candidate resource information, and transmit a random-access preamble to the base station 1700 via the PRACH resource. The base station may also identify the PRACH resource information corresponding to the beam related to the received second signal, and receive the random-access preamble via the PRACH resource.

However, according to the embodiment, if the base station fails to decode the second signal transmitted on the UDCH, a preamble signal transmitted by the UE may act as interference to other transmissions.

Hereinafter, according to another embodiment of the disclosure, a new preamble transmission structure and design for improving preamble efficiency will be described.

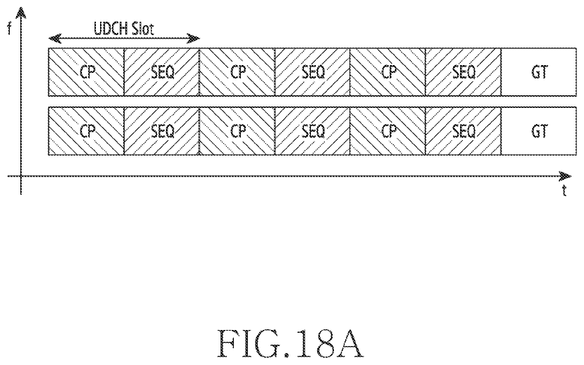

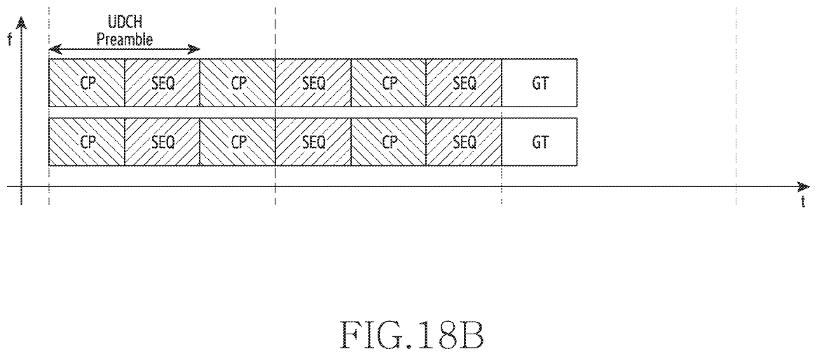

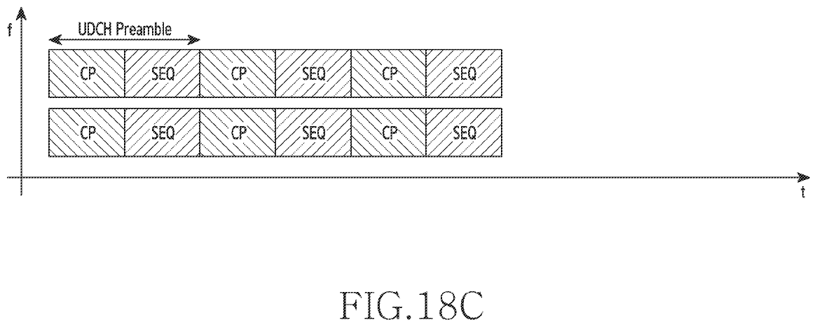

FIG. 18A to FIG. 18C illustrate a random-access preamble structure according to an embodiment of the disclosure.

FIG. 18A proposes a structure in which no guard time exists between PRACH time slots, and one guard time exists only at a last point in time when consecutive PRACH time slots end.

When the proposed structure is used, since there is no guard time between the consecutive PRACH time slots, a cell with wider coverage may be supported by using a longer CP, and a sequence reception success probability and an SINR may be further improved due to a long sequence length.

For example, when comparing the preamble of FIG. 18A with a preamble of an existing structure having an identical PRACH time slot length of 10 μsec, the structure of FIG. 18A may support wider coverage due to increased CP and sequence lengths so that approximately 60% additional coverage may be secured. When converting this to an area, 1.5 times of area may be additionally supported, thereby allowing a very large cell.

Alternatively, as in FIG. 18B, a PRACH time slot in the form of a reduced resource overhead may be configured, the PRACH time slot having a short-length PRACH time slot supporting the same coverage.

As in FIG. 18C, short preamble type AI without guard time exists also in NR. This unusual type where only a CP and a sequence exist is defined to be used only when uplink criteria are satisfied and there is no need to consider a delay spread.

On the other hand, the preamble structure according to an embodiment of the disclosure can support any case of random access by including guard time once at the end. Various methods of configuring a guard time once at the end are described in detail below.

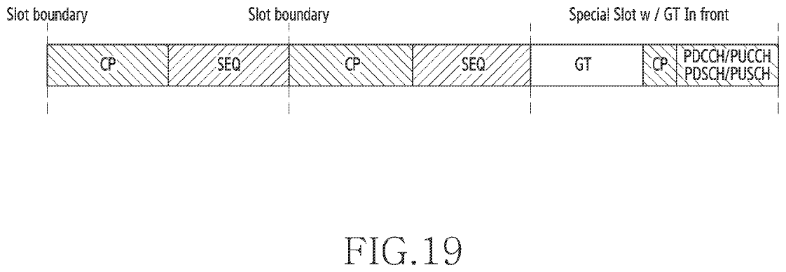

FIG. 19 is a diagram illustrating an example of a random-access preamble structure according to an embodiment of the disclosure.

According to FIG. 19, an embodiment of the disclosure proposes a “special frame (special slot) in which a guard time exists in the front”. For example, consecutive PRACH time slots exactly end at a data slot boundary, and a first slot connected subsequent thereto may include a special frame in which a guard time is in the front and signal transmission starts from the middle (e.g., a predetermined point) thereafter. To this end, a special frame with such a format should be standardized and supported in the standards, and a method indicating when and how to configure and use the special frame should also be standardized.

Special frame configuration methods according to various embodiments of the disclosure are described below.
a) Fixed and constant allocation: A first slot subsequent to an RA occasion burst is always configured as a special slot.
b) Allocation via indicator: When an indicator is included in information including RACH configuration, such as SIB1 and an RRC message, a first slot subsequent to each RA occasion burst is configured as a special slot.
c) Allocation via TDD configuration: A TDD configuration considering a special frame is indicated and configured.
d) Allocation via RA preamble type. An RA preamble structure having a GT at the end is configured in the standards, and indicated and configured as an RA preamble type.

In addition, the following content may be combined with the disclosure.

Summary—Random access in mobile communication networks is used for uplink timing synchronization. At high carrier frequencies, random-access inefficiency due to resource overheads is increased by a long preamble length and a large number of beam directions. In this document, random-access preamble transmission at high carrier frequencies is extensively studied, and the document proposes a new on-demand random-access protocol (OD-RAP) design that enables reduction of random-access resource overheads in B5G and 60 mobile communication networks operating at high frequencies. Assessment shows that the proposed OD-RAP design causes reduction of random-access resource overheads by more than 50%.

Keywords—B5G, 6G, high frequency, and random access

### I. INTRODUCTION

Wireless mobile communication networks have evolved from the first generation in the 1970s to the current fifth generation networks that have already been deployed worldwide. With evolution of the wireless communication technology, operating carrier frequencies are also increasing to meet an increasing demand for high data transmission rates and capacity. Table 2 shows typical operating carrier frequencies and peak data transmission rates of wireless mobile communication networks of various generations [1].

As carrier frequencies increase, wireless networks can utilize wider carrier bandwidths to support high data transmission rates. In recently designed 5G systems based on orthogonal frequency division multiplexed access (OFDMA) operating at high carrier frequencies, high subcarrier spacing (SCS) is also used in addition to wide carrier bandwidths. High SCS results in reduced OFDM symbol lengths which enable wireless networks operating at high carrier frequencies to achieve both high data rates and reduced latency [2].

On the other hand, high carrier frequencies also have drawbacks. An increase in carrier frequency increases a path loss and consequently reduces cell coverage [3]. In order to overcome the reduced cell coverage, 5G systems adopt analog beamforming in which large-scale antennas are used to accumulate transmission and reception power in a specific direction.

The directivity of analog beamforming exposes additional overheads, such as beam training and beam sweeping reference signals for multiple (up to 64141) beam directions in 5G.

TABLE 2
Carrier frequencies and peak data rates of wireless
mobile networks of various generations

| | 1st | | 2nd | | 3rd | | 4th | | 5th | |
|---|---|---|---|---|---|---|---|---|---|---|
| Generation | Generation | | Generation | | Generation | | Generation | | Generation | |
| Frequency | 30 | KHz | 1.8 | GHz | ~2.1 | GHz | ~2.7 | GHz | ~30 | GHz |
| Highest Data | 2.4 | kbps | 200 | kbps | 30 | Mbps | 1 | Gbps | 10 | Gbps |
| Rate | | | | | | | | | | |

In addition, high carrier frequencies also require expensive and high-performance hardware, such as advanced oscillators, amplifiers, filters, and processors.

In a mobile communication network, a critical and important functionality that enables communication between a user equipment (UE) and the network is random access (RA). The main purpose of RA is to enable UEs, which have not yet acquired or lost uplink (UL) synchronization, to achieve UL time synchronization. For successful RA, a) a UE should be uniquely identified, and b) a UL transmission delay of the UE should be accurately measured during the RA. After the successful RA, the UE and the network are uplink synchronized, and the UE may be scheduled for downlink (DL) or UL data transmission. At high carrier frequencies, resource efficiency of RA is reduced due to extended preamble lengths and multiple beam directions. In a beamformed environment, conventional Zadoff-Chu sequence-based RA preamble (RAP) transmission may no longer be efficient. In the document, an overhead of beamformed RA is extensively studied. In the document, key functions of RAP, such as “UE detection” and “delay measurement”, to diversify the number of parameters are studied. In addition, the document proposes a new on-demand random-access protocol (OD-RAP) that enables reduction of random-access resource overheads.

The remainder of the document includes the followings: In section II, the document presents existing random-access protocols in cellular systems. Random-access overheads at high carrier frequencies are analyzed in section III. The proposed on-demand random-access protocol is described in section IV and analyzed in section V. Finally, section VI concludes this work.

### II. RANDOM-ACCESS IN CELLULAR SYSTEMS

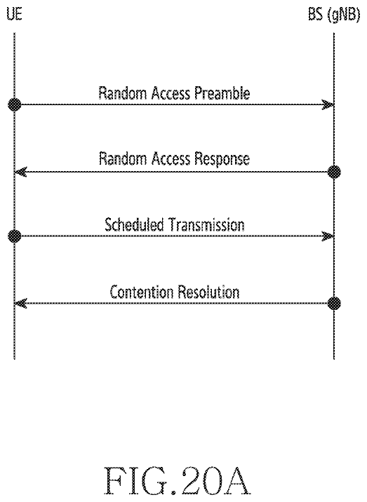

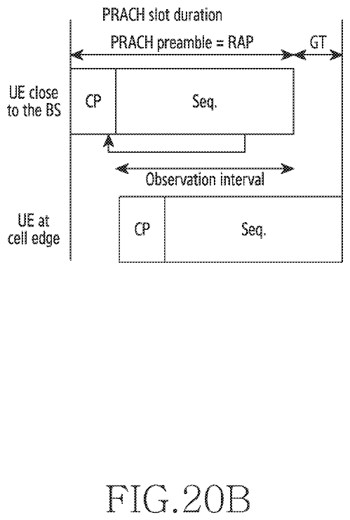

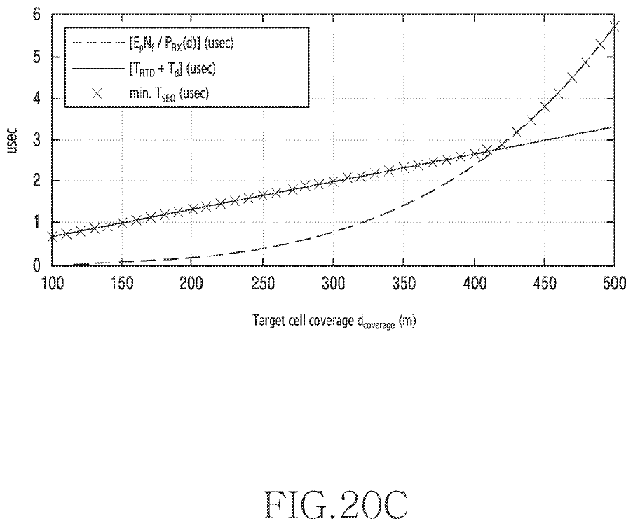

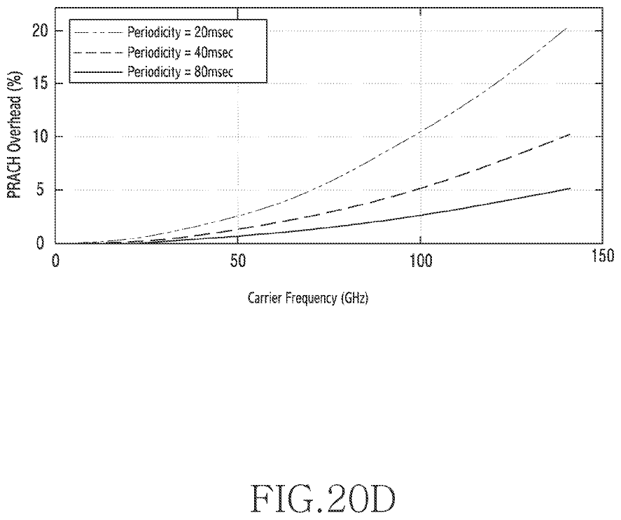

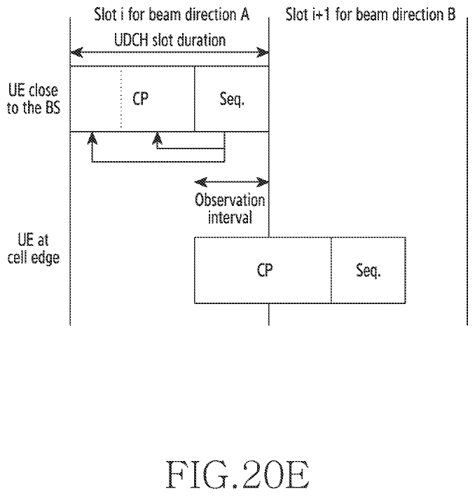

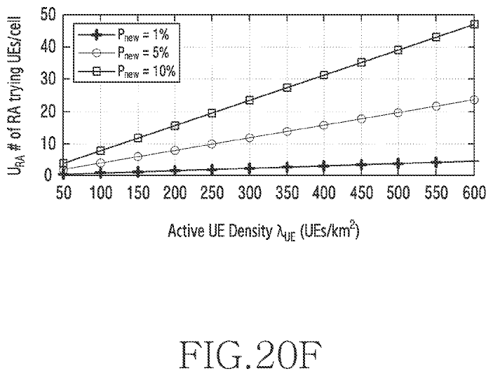

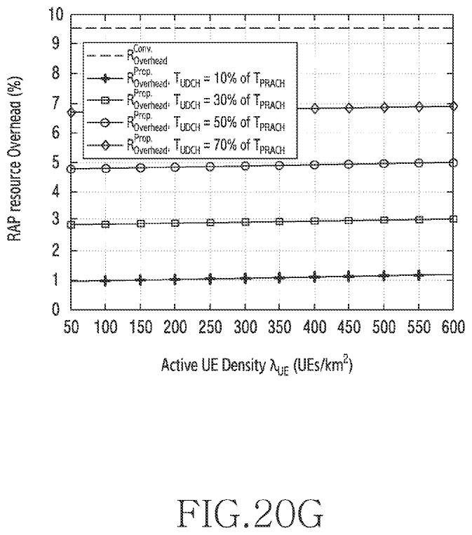

FIG. 20A is a diagram illustrating a conventional random-access procedure. A conventional RA procedure is illustrated in FIG. 20A 151. In a first operation, a UE transmits an RAP (referred to as Msg1) in a physical random-access channel (PRACH) slot. For beamformed RA, a PRACH slot and/or preamble are mapped to a DL beam. The UE selects a PRACH slot and/or preamble corresponding to a DL beam having a signal quality equal to or higher than a threshold. The signal quality is measured for a signal transmitted by a network (e.g., a base station (BS) or a 5G node B (gNB)) in each DL beam. After the RAP transmission, the UE monitors a random-access response (i.e., Msg2) from the network within a configured window. The response includes a UL grant, a timing advance, and an identifier (identity) of the detected RAP. When the random-access response is received, the UE transmits its own UE identity on UL (Msg3) by using the scheduled UL grant in the response, and monitors a contention resolution message (Msg4) from the network. When Msg4 including the UE's own identity is received, the contention resolution is determined to be successful, and the RA procedure is completed.

FIG. 20B is a diagram illustrating a PRACH slot configuration for RAP transmission. As illustrated in FIG. 20B, a PRACH slot for RAP transmission includes a cyclic prefix (CP), a preamble sequence, and a guard time (GT) [6]. RAP is also referred to as PRACH preamble. In the PRACH slot, a BS detects an RAP from a UE and performs correlation between RAP sequences during a specific observation period to measure a delay.

In the related art, an RAP sequence length is selected based on a number of requirements. One of the requirements is that the sequence length should be an integer multiple of a symbol period (T_{S}), i.e., T_{SEQ}=k·TS. In order to guarantee successful reception by considering false alarms and error detection, T_{SEQ} needs to satisfy a required preamble sequence energy ratio, EₚN₀/, to thermal noise, as follows [6]:

$${T}_{SEQ} \geq \frac{{N}_{0} {N}_{f}}{{P}_{R x} ( r , f )} \frac{{E}_{p}}{{N}_{0}} = \frac{{E}_{p} {N}_{f}}{{P}_{R x} ( r , f )} , \qquad ( 1 )$$

Here, N₀, N_{f}, Eₚ, and P_{Rx} denote noise power density (mW/Hz), receiver noise figure, required preamble sequence energy, and reception power, respectively. The reception power is affected by cell coverage (r) and carrier frequency (f). It is noted that target EₚN₀/ is determined to minimize the possibility of false alarms and error detection.

In addition, T_{SEQ} should have a lower limit value to compensate for asynchronous preamble transmission in a cell coverage area where delays vary from zero (center) to a maximum round-trip delay (edge). This is important for the RAP to accurately detect a delay within the observation period. Accurate delay detection may be achieved by having a single autocorrelation peak within a delayed preamble. To do so, the observation period should exactly match T_{SEQ}, as shown in FIG. 20B. The round-trip delay (RTD) may be processed by adding a DL propagation time of a reference signal (CRS or SSB) and a UL propagation time of the RAP. The RTD is calculated based on Tai-=2·dcoveragec/, where c and dcoverage denote a speed of light and target cell coverage that is identical to r, respectively.

Then, the lower limit value of T_{SEQ} is determined as follows:

$${T}_{SEQ} = {min}_{k ∈ N} ( {kT}_{s} )$$

$$s . t . {kT}_{s} \geq max ( {T}_{RTD} + {T}_{d} , \frac{{E}_{p} {N}_{f}}{{P}_{Rx} ( r , f )} ) , \qquad ( 2 )$$

Here, T_{d} and N denote a maximum expected delay spread and a natural number, respectively.

In the RAP, the CP and GT are selected to maximize coverage while absorbing delays among asynchronous UEs in a cell and inter-symbol interference from consecutive transmission, respectively. The CP and GT are determined as follows:

$${T}_{CP} = {min}_{k ∈ N} ( {kT}_{s} ) s . t . {kT}_{s} \geq {T}_{RTD} + {T}_{d} , \qquad ( 3 )$$

$${T}_{GT} = {min}_{k ∈ N} ( {kT}_{s} ) s . t . {kT}_{s} \geq {T}_{RTD} . \qquad ( 4 )$$

Ultimately, the RAP may have a length of T_{CP}+T_{SEQ}+T_{GT} which is an integer multiple of radio resource granularity, for example, a subframe (k′TSubframe) in a 4G system based on the 3GPP-LTE standards or a slot (k′TSlot) in a 5G system based on the 3GPP-NR standards. Here, k′ is a natural number that may be determined based on a network deployment scenario having target coverage.

### III. OVERHEAD OF LEGACY RANDOM-ACCESS PREAMBLE TRANSMISSION WITH INCREASING CARRIER FREQUENCY

Before 5G, wireless networks have operated at a carrier frequency of 30 GHz or lower, and most cellular networks, e.g., WCDMA, LTE, and NR, use the Zadoff-Chu sequence as RAP to detect a UE and measure delays in the networks. In this section, dynamics of CP and SEQ in RAP are discussed in terms of increasing carrier frequency and target coverage.

As described in section II, the CP and GT are determined based on the maximum RTD proportional to target cell coverage, regardless of carrier frequency. Table 3 shows required RTD sizes for different cell coverage. As shown in Equation (2), a preamble sequence length is determined based on both RTD and required reception power P_{Rx}(r,f). P_{Rx}(r,f) is affected by a path loss and may be described as follows:

$${P}_{Rx} ( r , f ) = {P}_{Tx} + {G}_{ant} - PL ( r , f ) - {P}_{Loss} ( dB ) , \qquad ( 5 )$$

Here, P_{Tx}, Gₐₙₜ, PL(r,f), and P_{Loss} denote UE transmission power, BS and UE antenna gain, path loss, and other losses such as transmission and shadowing, respectively.

Another key factor that defines an RAP overhead in a high-frequency system, such as 5G NR, is the number of DL beams. In order to compensate for a decrease in coverage caused by an increase in a path loss, NR has adopted a directional analog beamforming-based system that increases antenna gain by accumulating RF power emission in a specific direction by using large-scale antennas. Via the increased antenna gain, the NR system may also increase RAP reception power P_{Rx}, and this also reduces the lower limit value of T_{SEQ}.

TABLE 3
RTD required to diversify target coverage

| d_{coverage} | 100 m | 300 m | 500 m | 1 km | 10 km |
|---|---|---|---|---|---|
| T_{RTD} | 0.67 μsec | 2 μsec | 3.34 μsec | 6.67 μsec | 66.67 μsec |

In the analog beam-based high-frequency NR system, random access is also performed in a beam sweeping manner, for example, by sequentially transmitting and receiving preambles on predetermined radio resources designated in multiple beam directions. In consideration of up to 64 DL beams, the NR system requires up to 64 PRACH slots per period.

As the carrier frequency increases, an analog beam width may also be narrowed to compensate for reduced coverage via beam gain. For example, in order to compensate for a path loss of 6 dB caused by doubling of the carrier frequency, the system needs to increase antenna gain by 6 dB by using a beam width halved with the quadrupled number of beams. Accordingly, increasing of the antenna gain by using the narrow beam width will eventually increase the number of required beam directions, thereby increasing random-access resources or PRACH resource overheads (also known as RAP overheads) for RAP transmission.

In the high-frequency system with analog beam-based random access, an RAP overhead may be calculated as follows:

$${R}_{Overhead}^{RAP} = \frac{{N}_{beams} \cdot {BW}_{RA} \cdot {T}_{PRACH}}{{BW}_{tot} \cdot {T}_{period}^{RA}} , \qquad ( 6 )$$

Here, N_{beams} denotes the number of PRACH slots per period which may be expressed as N_{beams}=|S_{beams}|. S_{beams} denotes a set of beam directions for which PRACH slots should be scheduled. If a BS has one or more active RF/antenna chains, the BS may perform reception from two or more different beam directions simultaneously, so that the PRACH slots may be associated with one or more beams, and N_{beams} is reduced. In the document, for a fair comparison, BSs having only one active RF chain at a time are considered. BW_{RA}, BWₜₒₜ, and T_{period}^{RA} denote a frequency bandwidth of PRACH, an available carrier bandwidth, and a time period of full beam sweeping random access, respectively. N_{beams} is inversely proportional to an analog beam width and the number of beam directions that the BS is able to process simultaneously within T_{PRACH}.

In order to derive an RAP overhead for the increase of the carrier frequency, it is proposed to consider a system that always achieves fixed d_{coverage} with the evolving antenna technology that has sufficient gain of Gₐₙₜ to compensate for the increased path loss. Such increased Gₐₙₜ requires a larger number of array antennas and a narrower analog beam width which ultimately leads to reduced N_{beams}. Table 4 shows an example of required Gₐₙₜ and N_{beams} for diversifying the carrier frequency when d_{coverage} is fixed to 500 m. It is noted that a considered configuration of 24 GHz is aligned with the 3GPP NR FR2 configuration. With the antenna configurations in Table 4, Gₐₙₜ−PL(r,f) is constant, so that RAP reception power and P_{Rx} in Equation (5) become constant.

TABLE 4
Antenna configurations for various frequencies

| f | 3 GHz | 6 GHz | 12 GHz | 24 GHz | 48 GHz | 96 GHz |
|---|---|---|---|---|---|---|
| PL(d, f)(dB) | 128.58 | 134.6 | 140.62 | 146.64 | 152.66 | 158.68 |
| Gₐₙₜ (dB) | 10 | 16.02 | 22.04 | 28.06 | 34.08 | 40.1 |
| N_{beams} | 1 | 4 | 16 | 64 | 256 | 1024 |

Therefore, the lower limit value of T_{SEQ} in Equation (2) may be max (T_{RTD}+T_{d}, EₚN_{f}/P_{RX}(d)) regardless of carrier frequency f.

FIG. 20C is a diagram illustrating a lower limit value of T_{SEQ} for diversifying target coverage when antenna gain has been adjusted to compensate for an increased path loss. FIG. 20C shows the lower limit value of T_{SEQ} for diversifying target coverage when antenna gain has been adjusted to compensate for the increased path loss, as illustrated in Table 4. FIG. 20C shows that T_{SEQ} is affected by d_{coverage} and is bounded by T_{RTD}+T_{d} when d_{coverage}≤415 m, while T_{SEQ} is bounded by EₚN_{f}/P_{RX}(d) when d_{coverage}>415 m. For a small cell, RAP sequence length T_{SEQ} is sufficient for signal detection. For a large cell, T_{SEQ} is bounded by EₚN_{f}/P_{Rx}, and the system may, for example, reduce T_{SEQ} by reducing EₚN_{f}/P_{RX} by using a higher transmission power or a longer observation period.

With the T_{SEQ} and parameters in Table 4, FIG. 20D shows the total RAP overhead with various radio frequencies and antenna configurations. Here, a fixed ratio of BW_{RA}/BWₜₒₜ has been considered as 8.64/95.04 MHz (1/11 radio blocks)=9.1% acquired from NR, and a fixed d_{coverage}, of 500 m has been considered. For results, periodicity of RAP transmission is varied from 20 msec to 80 msec.

FIG. 20D is a diagram illustrating an RAP overhead of an existing 5G network. Referring to FIG. 20D, when T_{period}^{RA}=20 msec, an RAP overhead of the existing 5G network at 30 GHz is less than 2%. However, when the carrier frequency increases up to 142 GHz, the RAP overhead increases sharply to 20% or more of all available radio resources. In consideration that NR is designed to have a total resource overhead target of 20% with an RAP overhead of approximately 1.5%, it is obvious that the RAP overhead in the high-frequency system is too large.

In addition, increased N_{beams} in the high-frequency system ultimately increases the possibility of wasting PRACH resources. When considering various UE densities and RA trigger conditions, it is unlikely that there will always be a UE required to perform random access in each beam direction in each PRACH slot. Therefore, as N_{beams} increases, more PRACH resources will be wasted.

In order to overcome this excessive overhead and reduce equipment of PRACH resources, a new random-access protocol for high-frequency systems should be developed.

### IV. PROPOSED ON-DEMAND RANDOM-ACCESS PROTOCOL DESIGN IN B5G/6G HIGH-FREQUENCY SYSTEMS

In this section, an OD-RAP design for B5G and 6G mobile communication networks operating at high frequencies is proposed, wherein the design enables reduction of overheads and limitation of radio resource waste without affecting performance.

As described in section III, main components of the RAP overhead are T_{PRACH} and N_{beams} which denote a length of each PRACH slot and the number of periodically reserved PRACH slots, respectively. In conventional RAP transmission, overhead reduction is possible only at the expense of performance or high cost. If target coverage d_{coverage} is reduced, overheads are reduced, but the number of BS deployments should be increased. Increasing UE bandwidth BWₜₒₜ may reduce an overhead, but requires an increase in the cost of each UE. It is obvious that an increase of RAP transmission period T_{period}^{RA} reduces both an overhead and a random-access delay.

Among the main components of the RAP overhead, a length of T_{PRACH}, especially T_{SEQ}, is determined to enable successful signal and delay detection. Due to this, if there is no change in a network deployment scenario or RF capability, it is difficult to reduce T_{PRACH} without changing the sequence itself. Therefore, this document focuses on whether it is possible to reduce other components, i.e., the periodically reserved N_{beams} PRACH resources.

In conventional RA protocols, full beam sweeping-based N_{beams} preamble reception is required to accommodate all possible UEs in any beam direction within cell coverage at any time. However, in the high-frequency systems, N_{beams} becomes greater and RAP overheads increase. In order to reduce overheads and eliminate an unnecessary PRACH resource reservation, the document proposes a new RAP transmission protocol which dynamically schedules necessary PRACH slots only in a beam direction having at least one UE to perform RA. The proposed OD-RAP includes the following operations:

Operation 1: Beam indication using a new UL UE detection channel (UL UDCH): A UE transmits a preamble on an UDCH resource associated with an identified DL beam having a signal quality equal to or higher than a threshold value. Based on reception on the UDCH resource, the network determines a set of beam directions S_{beams}′, for example, a list of beam IDs, where each beam direction has at least one UE to perform RA. N_{beams}′ is represented as |S_{beams}′| This operation is basically performed as a request for a random-access resource in a specific beam direction.

Operation 2: Dynamic scheduling of PRACH resources (on-demand allocation): After determining S_{beams}′ by using UDCH, the network schedules PRACH resources associated with S_{beams}.

Operation 3: PRACH transmission and reception: RAP transmission/reception on scheduled PRACH resources.

Main content of the proposed OD-RAP is to divide conventional RAP functions into a “UE detection operation” and a “delay measurement operation”. Proposed operation 1, referred to as UDCH operation, is for fast S_{beams}′ detection, operation 2 is for PRACH resource scheduling on detected S_{beams}′, and operation 3 is for actual RAP transmission on scheduled N_{beams}′ PRACH slots. All these operations are to eliminate unnecessary PRACH resource allocation by flexible on-demand PRACH resource allocation based on S_{beams}′ detection. In operation 3, it is assumed that the design of each PRACH slot is the same as a conventional design for accurate delay detection.

It is proposed to design a UDCH with a new preamble format having a length of T_{UDCH}. In the proposed UDCH operation, the network needs to determine a set of beam directions S_{beams}′, each of which has at least one UE to perform RA. Since the UDCH is for unknown UE detection, N_{beams}′ full beam sweeping-based UDCH receptions are inevitable. In addition, when considering UL asynchronous UEs, a CP is required for each T_{UDCH}, and length Trp is the same as a CP from T_{PRACH}.

Unlike T_{PRACH}, sequence length TSEQUDCH may be shorter than the CP. The purpose of the UDCH is to detect the presence or absence of “any” UE to perform RA in each beam direction, and therefore, TSEQUDCH does not need to be as long as T_{PRACH} for delay detection. Furthermore, since no unique UE detection is required in this operation, there is no problem even if sequences are identical for all UEs in a given beam direction. Accordingly, when an autocorrelation sequence is used for the UDCH, locations and the number of maxim correlation values are not important. Therefore. TSEQUDCH may be shorter than the CP.

During the beam sweeping UDCH, there is no need to avoid inter-symbol interference between adjacent UDCH slots performing autocorrelation between different beam directions. Based on this, no GT is required in each UDCH slot.

One potential design of a new UDCH slot and the design principles described above are illustrated in FIG. 20E.

FIG. 20E is a diagram illustrating an RAP overhead of a proposed 5G network.

### V. ANALYSIS OF PROPOSED ON-DEMAND RANDOM ACCESS PROTOCOL

With the proposed UDCH design in section IV for the OD-RAP, a resource overhead of the proposed OD-RAP may be calculated as follows:

$${R}_{Overhead}^{RAP\_Prop} = {R}_{Overhead}^{UDCH} + {R}_{Overhead}^{Scheduling} + {R}_{Overhead}^{{RAP}^{′}} , \qquad ( 7 )$$

$${R}_{Overhead}^{UDCH} = \frac{{N}_{beams} \cdot {BW}_{UDCH} \cdot {T}_{UDCH}}{{BW}_{tot} \cdot {T}_{period}^{RA}} , \qquad ( 8 )$$

$${R}_{Overhead}^{Scheduling} = \frac{E ( {N}_{beams}^{′} ) \cdot {BW}_{schd} \cdot {T}_{schd}}{{BW}_{tot} \cdot {T}_{period}^{RA}} , \qquad ( 9 )$$

$${R}_{Overhead}^{{RAP}^{′}} = \frac{E ( {N}_{beams}^{′} ) \cdot {BW}_{PRACH} \cdot {T}_{PRACH}}{{BW}_{tot} \cdot {T}_{period}^{RA}} , \qquad ( 10 )$$

Here, R_{Overhead}^{UDCH} denotes a resource overhead of the UDCH operation (operation 1) and R_{Overhead}^{Scheduling} and R_{Overhead}^{RAP}′ denote resource overheads of operations 2 and 3 of the proposed protocol, respectively. BW_{UDCH}. BW_{schd}, and T_{schd} denote a UDCH bandwidth, a bandwidth for transmitting DL PRACH scheduling information, and a time period of each DL PRACH scheduling slot, respectively. It is noted that, since other beam directions may have neither scheduling information reception nor any UE for RA, R_{Overhead}^{Scheduling} considers N_{beams}′.

When referring to Equations (6) and (10), it is obvious that overhead R_{Overhead}^{RAP′} having N_{beams}′ is smaller than overhead R_{Overhead}^{RAP} having N_{beams}′. Then, the remaining question is whether additional overheads in operations 1 and 2 and Equations (8) and (9) can be smaller than the residual overhead of R_{overhead}^{RAP}′ having N_{beams}^{c}=N_{beams}−E(N_{beams}′). Here, the most important variable for the RAP resource overhead is E(N_{beams}′), while N_{beams}′ is affected by the density of UEs required to perform RA. Intuitively, it may be said that, as the UE density and N_{beams}′ increase, resource efficiency of the proposed RAP protocol becomes worse.

If λ_{UE} is the UE density defined as the number of UEs per km², then there are λ_{UE}πr², UEs in a cell having coverage of r=d_{coverage} in km. It may be required to derive, among these active UEs, the number of UEs that have triggered RA to transmit RAP via P_{RAC}H and U_{RA}. According to the 5G NR specifications [5], there are multiple events that trigger RA for a UE, and some of the major events are described as follows:
Initial access from RRC_IDLE;
Request by RRC upon synchronous reconfiguration (e.g., handover);
Beam failure recovery;
DL or UL data arrival during RRC_CONNECTED when UL synchronization status is “non-sychronised”;
RRC Connection Resume procedure from RRC_INACTIVE;

Here, the events of initial access, handover, and beam failure recovery are triggered by UE mobility. The events of data arrival and connection resumption are triggered by new data arrival after a significant amount of data-silence.

An RA trigger probability due to the events of UE mobility may be simplified as follows and modeled as a Poisson arrival rate of a new UE with respect to a particular cell [7]:

$${A}_{New} \sim Poisson ( {P}_{new {λ}_{UE}} π {r}^{2} ) , \qquad ( 11 )$$

Here, P_{new} denotes a ratio of newly added (woken up, handed over, . . . ) UEs among all active UEs. As coverage becomes wider due to handover, P_{new} decreases.

$${U}_{RA} = E ( {A}_{New} ) = {P}_{new {λ}_{UE}} π {r}^{2} . \qquad ( 12 )$$

RA trigger events of a second type are triggered when a network configuration timer that is referred to as a TimeAlignment timer (TAT) expires. The TAT expires when the UE does not have new data to receive a timing advance command from the BS after last communication. Then, the UE assumes that UL synchronization has been lost, and triggers RA. When T_{IAT} is an average inter-arrival time of traffic in UEs, then a traffic arrival rate of each UE may be expressed as:

$${A}_{traffic} \sim Poisson ( 1 / {T}_{IAT} ) . \qquad ( 13 )$$

Then, a probability that the UE experiences TAT timer expiration and triggers RA may be expressed as:

$$Pr \{ {A}_{traffic} > {T}_{TAT} \} = exp ( - {T}_{TAT} / {T}_{IAT} ) {T}_{IAT} , \qquad ( 14 )$$

Here, T_{TAT} denotes a network configuration TAT timer. It is noted that a CDF of a Poisson random variable is an exponential random variable.

Accordingly. U_{ULmiss} RA triggering UEs due to TAT timer expiration may be modeled as follows:

$${U}_{ULmiss} = Pr \{ {A}_{tr} \geq {T}_{TAT} \} ( 1 - {P}_{new} ) {λ}_{UE} π {r}^{2} . \qquad ( 15 )$$

It is noted that, since new UEs may trigger RA with or without TAT timer expiration, (1−P_{new})λ_{UE}πr² UEs are considered. Then, U_{RA} may be expressed as follows:

$${U}_{RA} = {U}_{New} + {U}_{ULmiss} = ( {P}_{new} + \frac{exp ( - {T}_{TAT} / {T}_{IAT} )}{{T}_{IAT}} ( 1 - {P}_{new} ) ) {λ}_{UE} π {r}^{2} . \qquad ( 16 )$$

In this document, N_{beams}′ is considered as the number of beams identified for RAP transmission within a given period. Selection of S_{beams}′ and corresponding N_{beams}′ is influenced by locations of users in different directions within a cell, and is a random variable. If U_{RA} is less than N_{beams}, a maximum possible value of N_{beams}′ is equal to U_{RA}, otherwise, the maximum possible value is bounded by N_{beams} as an upper bound. As a result, Equation N_{beams}′≤min (U_{RA}, N_{beams}) is established.

$${P}_{{N}_{beams}^{′}} = ( \begin{matrix}{N}_{beams} \\ {N}_{beams}^{′}\end{matrix} ) \frac{{b}_{{N}_{beams}^{′}}}{{N}_{beams}^{{U}_{RA}}} , \qquad ( 17 )$$

Here

$$( \begin{matrix}α \\ β\end{matrix} ) = \frac{α !}{β ! ( α - β ) !}$$

denotes a combinational operation, and bₙ denotes the number of cases in which exactly n beams are selected by all U_{RA} UEs, bₙ may be evaluated as follows:

$${b}_{n} = {n}^{{U}_{RA}} - {\sum }_{k = 1}^{n - 1} ( \begin{matrix}n \\ k\end{matrix} ) \times {b}_{k} \qquad ( 18 )$$

$$s . t . , 2 \leq n \leq {N}_{beams} \& {b}_{1} = 1.$$

In addition, E(N_{beams}′) is expressed as follows.

$$E ( {N}_{beams}^{′} ) = {\sum }_{{N}_{beams}^{′} = 1}^{min ( {U}_{RA} , {N}_{beams} )} {P}_{{N}_{beams}^{′}} {N}_{beams}^{′} . \qquad ( 19 )$$

In order to evaluate the overhead, the actual utilization number U_{RA} of parameters needs to be derived from real-world networks. Predicted T_{IAT} of various types of 4G traffic has been studied [9], and in Table 5, an average value of all types of traffic is summarized as 2.234 msec. According to the 5G NR RRC specifications [4], TAT timer value T_{TAT} may be selected from 500 msec to infinity. A typical density of active UEs in 5G is estimated to be 300 UEs/km² [10]. FIG. 20F is a diagram illustrating UEs that perform random access. FIG. 20F shows U_{RA} UEs that perform RA in a cell to diversify user density λ_{UE} and new user ratio P_{new} according to Equation (16). An extreme case of 600 active UEs and 10% of P_{new} is considered, f is configured to be 96 GHz, T_{IAT} is configured to be 2.234 ms, and T_{TAT} is configured to be 500 ms. In FIG. 20F, when λ_{UE}=300 and P_{new}=5%, the number of UEs performing RA in the cell is 11.78 UEs. When considering 5G NR having 64 beams and such a small number of U_{RA}, it is observed that 50 or more PRACH resources are wasted in each PRACH allocation period. FIG. 20G is a diagram illustrating overheads of conventional and proposed RAP protocols. In a state where U_{RA} and E(N_{beams}′) are to be derived, in FIG. 20G, the RAP resource overheads of the proposed OD-RAP protocol (Equation (7)) are compared with those of the conventional RA protocol (Equation (6)) for diversifying user density λ_{UE} and a UDCH sequence size. UDCH designs having various T_{UDCH} lengths from 10% to 70% of T_{PRACH} are considered. f is configured to be 96 GHz, T_{IAT} is configured to be 2.234 ms, T_{TAT} is configured to be 500 ms, T_{schd} is configured to be 1 slot, BW_{schd} is configured to have the same bandwidth as BW_{UDCH}, and P_{new} is configured to be 5%. FIG. 20G shows that the proposed OD-RAP protocol outperforms the existing RAP protocol even when T_{UDCH} is as large as 70% of T_{PRACH}. The proposed OD-RAP protocol significantly reduces resource overheads as UDCH sequence lengths decrease. For example, using a length of T_{UDCH} that is 30% of T_{PRACH} reduces approximately 70% of the resource overhead to 3% or less of the total radio frame resources.

### VI. CONCLUSION

In the document, the resource overhead of RAP transmission in B5G or 6G systems having high carrier frequencies is studied. As a result of numerical analysis, as a frequency increases, an RAP resource overhead increases, and as a result, when the frequency is higher than 142 GHz, the RAP resource overhead exceeds 20%. In order to reduce such an excessive RAP resource overhead, the document examines a method of separating “UE detection” and “delay measurement”, separation of which has been impossible in the existing communication network systems. The document proposes a new on-demand random-access protocol (OD-RAP) that enables reduction of overheads and limitation of radio resource waste without affecting performance. As a result of overhead analysis, it is found that the proposed OD-RAP protocol reduces overheads by approximately 70% compared to the existing RAP protocol that considers a short UDCH sequence length. In fact, it is expected that, by considering various parameters, such as cell coverage and active UE density within a cell, the proposed OD-RAP can be selectively used with the conventional RA protocol.

TABLE 5
Traffic arrival time on 4G network

| | | Video | Video | | |
|---|---|---|---|---|---|
| | VoIP | Call | Streaming | HTTP | FTP |
| T_{IAT} (ms) | 0.27 | 1.12 | 1.67 | 5.61 | 2.5 |

For further work, we intend to perform system-level simulations to verify our analysis and compare protocols. In addition, we intend to investigate a random-access delay that may be reduced in the proposed OD-RAP.

### REFERENCES

[1] Samsung, “Samsung 5G Vision Whitepaper,” https.//images.samsung.com/is/content/samsung/p5/global/business/networks/insight s/white-paper/5g-vision/White-Paper_Samsung-5G-Vision.pdf, August, 2015
[2] T. Rappaport et al., “Overview of millimeter wave communications for fifth generation (5G) wireless networks with a focus on propagation models,” in Proc. IEEE Trans. Antennas Propag., vol. 65, no. 12, pp. 6213-6230, December 2017.
[3] S. Sun et al., “Propagation path loss models for 5G urban micro- and macro-cellular scenarios,” in Proc. IEEE 83rd Veh. Technol. Conf. (VTC-Spring), May 2016, pp. 1-6.
[4] 3GPP TS38.331, “Radio Resource Control (RRC) protocol specification,” March. 2018.
[5] 3GPP TS38.300, “NR and NG-RAN Overall Description,” June. 2018.
[6] S. Sesia et al., “LTE: The UMTS Long Term Evolution From Theory to Practice,” John Wiley and Sons, Inc., 2011
[7] M. Laner, et al., “Users in Cells: a Data Traffic Analysis,” 2012 IEEE Wireless Communications and Networking Conference: Mobile and Wireless Networks. 2012
[8] M. Agiwal et al., “Mobile assisted directional paging for 5G communications,” in Proc. Transactions on Emerging Telecommunications Technologies, February, 2018
[9] A. Singh, et al., “Modeling LTE Access Network Arrival Process by MMPP (2),” 2nd European Teletraffic Seminar (ETS 2013), 2013
[10] D. López-Pérez, et al., “Towards 1 Gbps/UE in cellular systems: Understanding ultra-dense small cell deployments.” IEEE Communications Surveys Tutorials, vol. 17, no. 4, pp. 2078-2101, June 2015.

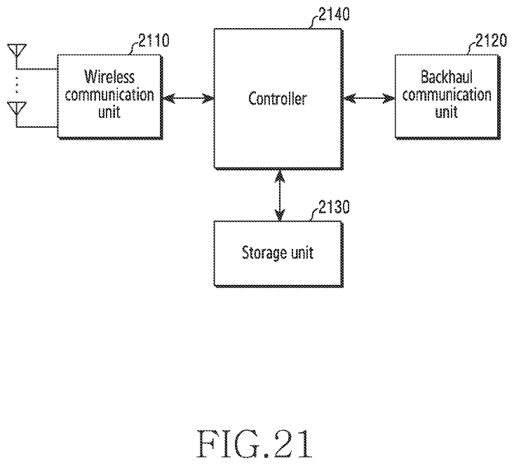

FIG. 21 illustrates a configuration of a base station in the wireless communication system according to an embodiment of the disclosure. The configuration illustrated in FIG. 21 may be understood as a configuration of a base station 2100. The terms “ . . . unit”. “ . . . device”, etc. used hereinafter refer to a unit configured to process at least one function or operation, and may be implemented as hardware, software, or a combination of hardware and software.

Referring to FIG. 21, the base station 2100 includes a wireless communication unit 2110, a backhaul communication unit 2120, a storage unit 2130, and a controller 2140. However, the elements of the base station are not limited to the example described above. For example, the base station may include more elements or fewer elements than the aforementioned elements. In addition, the wireless communication unit 2110, the backhaul communication unit 2120, the storage unit 2130, and the controller 2140 may be implemented in the form of a single chip. In addition, the controller 2140 may include one or more processors.

The wireless communication unit 2110 performs functions to transmit and receive a signal via a wireless channel. For example, the wireless communication unit 2110 performs a function of conversion between a baseband signal and a bitstream according to a physical layer specification of the system. For example, during data transmission, the wireless communication unit 2110 generates complex symbols by encoding and modulating a transmission bitstream. In addition, during data reception, the wireless communication unit 2110 restores a reception bitstream by demodulating and decoding a baseband signal.

In addition, the wireless communication unit 2110 up-converts a baseband signal to a radio frequency (RF) band signal, transmits the up-converted RF band signal via an antenna, and then down-converts an RF band signal received via the antenna to a baseband signal. To this end, the wireless communication unit 2110 may include a transmission filter, a reception filter, an amplifier, a mixer, an oscillator, a digital-to-analog converter (DAC), an analog-to-digital converter (ADC), and the like. In addition, the wireless communication unit 2110 may include multiple transmission/reception paths. Furthermore, the wireless communication unit 2110 may include at least one antenna array including multiple antenna elements.

In terms of hardware, the wireless communication unit 2110 may include a digital unit and an analog unit, wherein the analog unit includes multiple sub-units according to an operation power, an operation frequency, and the like. The digital unit may be implemented as at least one processor (e.g., a digital signal processor (DSP)).

The wireless communication unit 2110 transmits and receives a signal as described above. Accordingly, all or a part of the wireless communication unit 2110 may be referred to as “transmitter”, “receiver”, or “transceiver”. In addition, in the following description, transmission and reception performed via a wireless channel are used in a sense including processing performed as described above by the wireless communication unit 2110.

The backhaul communication unit 2120 provides an interface to perform communication with other nodes within a network. That is, the backhaul communication unit 2120 converts, into a physical signal, a bitstream transmitted from the base station 2100 to another node, for example, another access node, another base station, an upper node, a core network, or the like, and converts a physical signal received from another node into a bitstream.

The storage unit 2130 stores data, such as a basic program, an application program, and configuration information for operations of the base station 2100. The storage unit 2130 may include a volatile memory, a non-volatile memory, or a combination of a volatile memory and a non-volatile memory. In addition, the storage unit 2130 provides stored data in response to a request of the controller 2140.

The controller 2140 controls overall operations of the base station 2100. For example, the controller 2140 transmits and receives a signal via the wireless communication unit 2110 or the backhaul communication unit 2120. In addition, the controller 2140 records and reads data in the storage unit 2130. The controller 2140 may perform functions of a protocol stack required by the communication standards. According to another implement, the protocol stack may be included in the wireless communication unit 2110. To this end, the controller 2140 may include at least one processor. According to embodiments, the controller 2140 may control operations performed by the base station 2100 according to various embodiments of the disclosure described above.

For example, the controller 2140 may perform control to transmit a first signal including at least one reference signal to a UE, receive a second signal for notification of a UE location from the UE on a first uplink resource, identify, based on the second signal, a physical random-access channel (PRACH) resource corresponding to a reference signal selected by the UE, and receive a random-access preamble from the UE on the PRACH resource.

For example, the controller 2140 may further perform control to transmit a third signal including information on the PRACH resource to the UE.

For example, the controller 2140 may further perform control to transmit at least one of information on a first uplink resource corresponding to each reference signal, information on a resource on which the third signal is transmitted, and information on a PRACH resource corresponding to each reference signal to the UE via the first signal or via a separate signal.

For example, the controller 2140 may further perform control to transmit at least one of information on the first uplink resource corresponding to each reference signal and information on the PRACH resource corresponding to each reference signal to the UE via the first signal or via a separate signal.

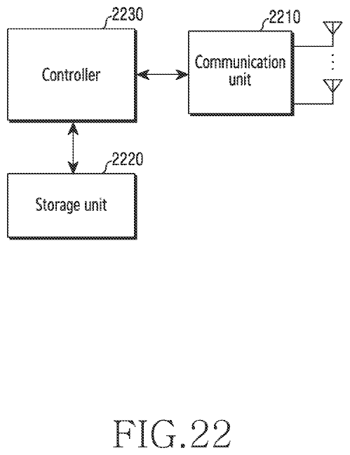

FIG. 22 is a diagram schematically illustrating a configuration of a UE in the wireless communication system according to an embodiment of the disclosure.

The configuration illustrated in FIG. 22 may be understood as a configuration of a UE 2200. The terms “ . . . unit”, “ . . . device”, etc. used hereinafter refer to a unit configured to process at least one function or operation, and may be implemented as hardware, software, or a combination of hardware and software.

Referring to FIG. 22, the UE 2200 includes a communication unit 2210, a storage unit 2220, and a controller 2230. However, elements of the UE 2200 are not limited to the example described above. For example, the UE 2200 may include more elements or fewer elements than the aforementioned elements. In addition, the communication unit 2210, the storage unit 2220, and the controller 2230 may be implemented in the form of a single chip. In addition, the controller 2230 may include one or more processors.

The communication unit 2210 performs functions for transmitting and receiving a signal via a wireless channel. For example, the communication unit 2210 performs a function of conversion between a baseband signal and a bitstream according to a physical layer specification of the system. For example, during data transmission, the communication unit 2210 generates complex symbols by encoding and modulating a transmission bitstream. When receiving data, the communication unit 2210 restores a reception bitstream by demodulating and decoding a baseband signal. In addition, the communication unit 2210 up-converts a baseband signal to an RF band signal, transmits the up-converted RF band signal via an antenna, and then down-converts an RF band signal received via the antenna to a baseband signal. For example, the communication unit 2210 may include a transmission filter, a reception filter, an amplifier, a mixer, an oscillator, a DAC, an ADC, and the like.

In addition, the communication unit 2210 may include multiple transmission/reception paths. Furthermore, the communication unit 2210 may include at least one antenna array including multiple antenna elements. In terms of hardware, the communication unit 2210 may include a digital circuit and an analog circuit (e.g., a radio frequency integrated circuit (RFIC)). The digital circuit and the analog circuit may be implemented in a single package. In addition, the communication unit 2210 may include multiple RF chains. Further, the communication unit 2210 may perform beamforming.

The communication unit 2210 transmits and receives a signal as described above. Accordingly, all or a part of the communication unit 2210 may be referred to as “transmitter”, “receiver”, or “transceiver”. In addition, in the following description, transmission and reception performed via a wireless channel are used in a sense including processing performed as described above by the communication unit 2210.

The storage unit 2220 stores data, such as a basic program, an application program, and configuration information for operations of the UE 2200. The storage unit 2220 may include a volatile memory, a non-volatile memory, or a combination of a volatile memory and a non-volatile memory. In addition, the storage unit 2220 provides stored data in response to a request of the controller 2230.

The controller 2230 controls overall operations of the UE 2200. For example, the controller 2230 transmits and receives a signal via the communication unit 2210. In addition, the controller 2230 records and reads data in the storage unit 2220. In addition, the controller 2230 may perform functions of a protocol stack required by the communication standards. To this end, the controller 2230 may include at least one processor or micro-processor, or may be apart of a processor. In addition, a part of the communication unit 2210 and the controller 2230 may be referred to as a communication processor (CP). According to embodiments, the controller 2230 may control operations performed by the UE 2200 according to various embodiments of the disclosure described above.

For example, the controller 2230 may perform control to receive a first signal including at least one reference signal from a base station, transmit a second signal for notification of a UE location to the base station on a first uplink resource corresponding to a reference signal selected by measuring the at least one reference signal, and transmit a random-access preamble on a physical random-access channel (PRACH) resource corresponding to the selected reference signal.

For example, the controller 2230 may further perform control to receive a third signal including information on the PRACH resource corresponding to the selected reference signal from the base station.

For example, the controller 2230 may further perform control to receive at least one of information on a first uplink resource corresponding to each reference signal, information on a resource on which the third signal is transmitted, and information on a PRACH resource corresponding to each reference signal from the base station via the first signal or via a separate signal.

For example, the controller 2230 may further perform control to receive at least one of information on the first uplink resource corresponding to each reference signal and information on the PRACH resource corresponding to each reference signal from the base station via the first signal or via a separate signal, and to identify the PRACH resource corresponding to the selected reference signal, based on the information on the PRACH resource corresponding to each reference signal.

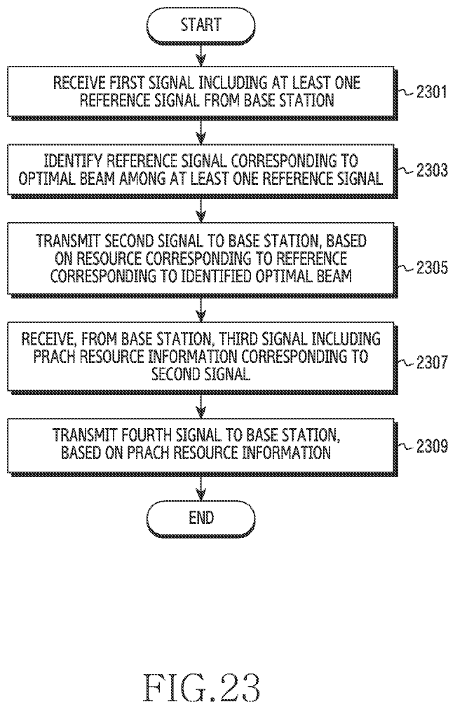

FIG. 23 is a flowchart for illustrating a random-access preamble transmission procedure of a UE according to an embodiment of the disclosure.

Referring to FIG. 23, in operation 2301, a UE may receive a first signal including at least one reference signal from a base station. In this case, the first signal may include a synchronization signal (SS) or a broadcast signal (e.g., a master information block (MIB) or a system information block (SIB)). For another example, the first signal may not include a synchronization signal. For another example, the first signal may not include a broadcast signal. If the first signal does not include a broadcast signal, the base station may transmit a broadcast signal to the UE via a separate signal. The broadcast signal may include, for example, at least one of UDCH uplink resource information and downlink resource information for transmission of SIB-α that is certain system information. SIB-α may be, for example, a signal including PRACH resource information according to an embodiment of the disclosure. Here, SIB-α resource information is resources expressed in frequency and time, and a reference signal (beam) having a correlation (e.g., quasi co location, hereinafter, QCL relationship) with each resource may be configured. The resources may be fixedly allocated all the time, or when variable allocation is needed, for example, when an uplink signal is received/detected via a UDCH correlated with a certain reference signal, only a downlink channel correlated with the reference signal may be allocated. An indicator indicating determination on this allocation may also be included in the broadcast signal. The UDCH may be a channel via which a signal transmitted by the UE to the base station is transmitted in order to identify a base station beam via which the base station is able to communicate with the UE, according to the embodiment of the disclosure. UDCH resource information is resources expressed in frequency and time, and a reference signal (beam) having a correlation (e.g., QCL relationship) with each resource may also be directly configured. Alternatively, indirectly, information on multiple channel resources configured in the standards and an ID indicating the reference signal (beam) correlated with each resource may be transmitted and configured via the broadcast signal. For example, the broadcast signal may include PRACH resource information for each beam according to an embodiment.

In operation 2303, the UE may identify a reference signal corresponding to an optimal beam among at least one reference signal. According to an embodiment, the UE may identify UDCH resource information, which enables uplink signal transmission, via the received broadcast signal, and select a UDCH resource corresponding to the selected reference signal (beam) by measuring the reference signal. The UE may select a reference signal having the best performance (RSSI, RSRP, RSRQ, CQI, etc.) while changing its reception antenna configuration (by changing a beam direction) or may select a reference signal exceeding a specific threshold value. In addition, the reference signal corresponding to the optimal beam may be selected in various ways.

In operation 2305, the UE may transmit a second signal to the base station, based on the resource corresponding to the reference signal corresponding to the identified optimal beam. According to an embodiment, the UE may transmit the second signal (e.g., a user detection signal) on the UDCH resource that is correlated (e.g., QCL-ed) with the determined reference signal (beam). The second signal is used by the base station to receive or detect the second signal from the UDCH and identify the reference signal or beam that is correlated with the UDCH. That is, the base station may receive the second signal to identify the reference signal (or beam) corresponding to a base station beam direction in which communication with the UE is estimated to be possible.

In operation 2307, the UE may receive, from the base station, a third signal including physical random-access channel (PRACH) resource information corresponding to the second signal. According to an embodiment, the UE may receive the third signal including the PRACH resource information via the SIB-α resource. The third signal may have a newly defined SIB-α protocol. The PRACH resource information may include resource configuration information related to the reference signal (beam) which has been identified based on the second signal received on the UDCH and corresponds to the base station beam direction in which communication with the UE is estimated to be possible. The PRACH resource information may include resource information expressed in frequency and time, or may indicate some or all of the PRACH resources configured above via the broadcast signal in a bitmap format. According to an embodiment of the disclosure, the UE may receive no third signal. In this case, the UE may identify resource information corresponding to the reference signal (beam) determined in the PRACH resource information (resource information configuration for each beam) received via the broadcast signal. That is, the UE that has informed, via the UDCH, the base station of the base station beam direction in which communication with the UE is estimated to be possible may identify the PRACH resource associated with the base station beam corresponding to the UDCH without receiving additional signaling.

In operation 2309, the UE may transmit a fourth signal to the base station, based on the PRACH resource information. The UE may transmit a random-access preamble, based on the PRACH resource information. For example, the UE may transmit the random-access preamble on the identified PRACH resource. The UE may start random access by transmitting the random-access preamble via the PRACH resource that is correlated with the determined reference signal (beam).

According to various embodiments of the disclosure, a method performed by a base station in a wireless communication system may be provided. The method may include transmitting a first signal to a UE, the first signal including user equipment (UE) detection channel (UDCH) resource information for UE selection, and receiving, from the UE, a second signal including UE detection information, based on the UDCH resource information in an observation period corresponding to a period for UE detection, wherein the observation period is longer than or equal to a preamble length included in the second signal.

According to an embodiment of the disclosure, the observation period may further include at least one of a preamble length duplicated by a cyclic prefix (CP) included in the second signal or a guard time (GT) length included in the second signal.

According to an embodiment of the disclosure, the observation period may be determined by one of the base station, an access management function (AMF) configured to communicate with the base station, or a session management function (SMF) configured to communicate with the base station.

According to an embodiment of the disclosure, the method may further include transmitting, to the UE, a third signal including physical random-access channel (PRACH) resource information corresponding to the second signal, and receiving a fourth signal from the UE, based on the PRACH resource information.

According to various embodiments of the disclosure, a method performed by a UE may be provided. The method may include receiving a first signal from a base station, the first signal including user equipment (UE) detection channel (UDCH) resource information for UE selection, and transmitting, to the base station, a second signal including UE detection information, based on the UDCH resource information, wherein an observation period corresponding to a period in which the base station receives the second signal is longer than or equal to a preamble length included in the second signal.

According to an embodiment of the disclosure, the observation period may further include at least one of a preamble length duplicated by a cyclic prefix (CP) included in the second signal or a guard time (GT) length included in the second signal.

According to an embodiment of the disclosure, the method may further include receiving, from the base station, a third signal including physical random-access channel (PRACH) resource information corresponding to the second signal, and transmitting a fourth signal to the base station, based on the PRACH resource information.

According to various embodiments of the disclosure, a base station in a wireless communication system may be provided. The base station may include a transceiver, and a controller connected to the transceiver, wherein the controller is configured to transmit a first signal to a UE, the first signal including user equipment (UE) detection channel (UDCH) resource information for UE selection, and receive, from the UE, a second signal including UE detection information, based on the UDCH resource information in an observation period corresponding to a period for UE detection, wherein the observation period is longer than or equal to a preamble length included in the second signal.

According to various embodiments of the disclosure, a UE in a wireless communication system may be provided. The UE may include a transceiver, and a controller connected to the transceiver, wherein the controller is configured to receive a first signal from a base station, the first signal including user equipment (UE) detection channel (UDCH) resource information for UE selection, and transmit, to the base station, a second signal including UE detection information, based on the UDCH resource information, wherein an observation period corresponding to a period in which the base station receives the second signal is longer than or equal to a preamble length included in the second signal.

According to the disclosure, a method performed by a UE may include: receiving a first signal including at least one reference signal from a base station: identifying a reference signal corresponding to an optimal beam among the at least one reference signal; transmitting a second signal to the base station, based on a resource corresponding to the identified reference signal corresponding to the optimal beam, receiving, from the base station, a third signal including physical random-access channel (PRACH) resource information corresponding to the second signal; and transmitting a fourth signal to the base station, based on the PRACH resource information.

According to the disclosure, a method for random access of a UE in a wireless communication system may include: receiving a first signal including at least one reference signal from a base station; measuring the at least one reference signal; based on a result of the measurement, identifying a reference signal corresponding to an optimal beam; transmitting a second signal including a user identification signal to the base station, based on a resource corresponding to the identified reference signal corresponding to the optimal beam; receiving, from the base station, a third signal including physical random-access channel (PRACH) resource information corresponding to the second signal; and transmitting a fourth signal including a random-access preamble to the base station, based on the PRACH resource information.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an extremal port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The operations proposed in various embodiments of the disclosure may be performed in combination into a single sequence to the extent that they do not conflict with each other. That is, in order to transmit a preamble for performing a random access procedure, each of the UE and the base station may perform at least two operations provided in various embodiments proposed above in combination to the extent that they do not conflict with each other.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a base station in a wireless communication system, the method comprising:
transmitting a first signal to a terminal, the first signal comprising user equipment (UE) detection channel (UDCH) resource information for terminal selection, and
receiving, from the terminal, a second signal comprising terminal detection information, based on the UDCH resource information in an observation period corresponding to a period for terminal detection,
wherein the observation period is longer than or equal to a preamble length included in the second signal.

2. The method of claim 1, wherein the observation period further comprises at least one of a preamble length duplicated by a cyclic prefix (CP) included in the second signal or a guard time (GT) length included in the second signal.

3. The method of claim 1, wherein the observation period is determined by one of the base station, an access management function (AMF) configured to communicate with the base station, or a session management function (SMF) configured to communicate with the base station.

4. The method of claim 1, further comprising:
transmitting, to the terminal, a third signal comprising physical random-access channel (PRACH) resource information corresponding to the second signal; and
receiving a fourth signal from the terminal, based on the PRACH resource information.

5. A method performed by a terminal in a wireless communication system, the method comprising:
receiving a first signal from a base station, the first signal comprising user equipment (UE) detection channel (UDCH) resource information for terminal selection; and
transmitting, to the base station, a second signal comprising terminal detection information, based on the UDCH resource information,
wherein an observation period corresponding to a period in which the base station receives the second signal is longer than or equal to a preamble length included in the second signal.

6. The method of claim 5, wherein the observation period further comprises at least one of a preamble length duplicated by a cyclic prefix (CP) included in the second signal or a guard time (GT) length included in the second signal.

7. The method of claim 5, further comprising:
receiving, from the base station, a third signal comprising physical random-access channel (PRACH) resource information corresponding to the second signal; and
transmitting a fourth signal to the base station, based on the PRACH resource information.

8. A base station in a wireless communication system, the base station comprising:
a transceiver; and
a controller coupled with the transceiver,
wherein the controller is configured to:
transmit a first signal to a terminal, the first signal comprising user equipment (UE) detection channel (UDCH) resource information for terminal selection; and
receive, from the terminal, a second signal comprising terminal detection information, based on the UDCH resource information in an observation period corresponding to a period for terminal detection,
wherein the observation period is longer than or equal to a preamble length included in the second signal.

9. The base station of claim 8, wherein the observation period further comprises at least one of a preamble length duplicated by a cyclic prefix (CP) included in the second signal or a guard time (GT) length included in the second signal.

10. The base station of claim 8, wherein the observation period is determined by one of the base station, an access management function (AMF) configured to communicate with the base station, or a session management function (SMF) configured to communicate with the base station.

11. The base station of claim 8, wherein the controller is further configured to:
transmit, to the terminal, a third signal comprising physical random-access channel (PRACH) resource information corresponding to the second signal; and
receive a fourth signal from the terminal, based on the PRACH resource information.

12. A terminal in a wireless communication system, the terminal comprising:
a transceiver; and
a controller coupled with the transceiver,
wherein the controller is configured to:
receive a first signal from a base station, the first signal comprising user equipment (UE) detection channel (UDCH) resource information for terminal selection; and
transmit, to the base station, a second signal comprising terminal detection information, based on the UDCH resource information,
wherein an observation period corresponding to a period in which the base station receives the second signal is longer than or equal to a preamble length included in the second signal.

13. The terminal of claim 12, wherein the observation period further comprises at least one of a preamble length duplicated by a cyclic prefix (CP) included in the second signal or a guard time (GT) length included in the second signal.

14. The terminal of claim 12, wherein the observation period is determined by one of the base station, an access management function (AMF) configured to communicate with the base station, or a session management function (SMF) configured to communicate with the base station.

15. The terminal of claim 12, wherein the controller is further configured to:
receive, from the base station, a third signal comprising physical random-access channel (PRACH) resource information corresponding to the second signal; and
transmit a fourth signal to the base station, based on the PRACH resource information.
